(19) United States
(12) Patent Application Publication
(10) Pub. No.: US 2024/0023143 A1
(43) Pub. Date: Jan. 18, 2024

(54) METHODS FOR SIDELINK COMMUNICATIONS, TERMINAL DEVICES, NETWORK DEVICES, AND COMPUTER READABLE MEDIA

(71) Applicant: Lenovo (Beijing) Limited, Beijing (CN)

(72) Inventor: Haiming Wang, Beijing (CN)

(73) Assignee: Lenovo (Beijing) Limited, Beijing (CN)

(21) Appl. No.: 18/251,301

(22) PCT Filed: Nov. 3, 2020
(86) PCT No.: PCT/CN2020/126224

§ 371 Date: May 1, 2023

(51) Int. Cl. H04W 72/40; H04W 16/28; H04W 72/51

(52) U.S. Cl. CPC H04W 72/40; H04W 16/28; H04W 72/51

(57) ABSTRACT

Embodiments of the present disclosure relate to a solution for improving sidelink communications between terminal devices. In a method for communication, a first terminal device may transmit an assistance information to a network device. The assistance information may be used by the network device to determine a sidelink resource for a sidelink communication between the first terminal device and a second terminal device. Then, the first terminal device can receive an indication of the sidelink resource determined based on the assistance information from the network device. Afterwards, the first terminal device may perform the sidelink communication between the first and the second terminal devices using the sidelink resource. In this way, the resource utilization efficiency can be enhanced or the interference level may be reduced in sidelink communications, thereby improving the performance of the sidelink communications.

### FIELD

Embodiments of the present disclosure generally relate to the field of communication, and in particular to methods for sidelink communications, terminal devices, network devices, and computer readable media.

### BACKGROUND

5G New Radio (NR) is the 5th generation mobile network. It is a new global wireless standard after 1G, 2G, 3G, and 4G networks. 5G enables a new kind of network that is designed to connect virtually everyone and everything together including machines, objects, and devices. 5G wireless technology is meant to deliver higher multi-Gbps peak data speeds, ultra-low latency, more reliability, massive network capacity, increased availability, and a more uniform user experience to more users. Higher performance and improved efficiency empower new user experiences and connects new industries.

To expand the 3rd Generation Partnership Project (3GPP) platform to the automotive industry, the standard of Vehicle-to-Everything (V2X) service or sidelink communication has been investigated in Releases 14 to 16 and has been developed further in Release 17. Specifically, Release 14 carries out a 4G Long Term Evolution (LTE) based V2X standard work (Phase 1), Release 15 involves a continuous LTE based V2X standard evolution (Phase 2), Release 16 provides a NR based V2X design (Phase 3), and Release 17 relates to a further NR based V2X design (Phase 4).

### SUMMARY

In general, embodiments of the present disclosure provide a solution for improving sidelink communications between terminal devices, especially for enhancing resource utilization efficiency and reducing interference in sidelink communications.

In a first aspect, there is provided a method performed by a first terminal device. The method comprises transmitting, to a network device, an assistance information to be used by the network device to determine a sidelink resource for a sidelink communication between the first terminal device and a second terminal device. The method also comprises receiving, from the network device, an indication of the sidelink resource determined based on the assistance information. The method further comprises performing the sidelink communication between the first and the second terminal devices using the sidelink resource.

In a second aspect, there is provided a method performed by a network device. The method comprises receiving, from a first terminal device, an assistance information to be used by the network device to determine a sidelink resource for a sidelink communication between the first terminal device and a second terminal device. The method also comprises determining the sidelink resource based on the assistance information. The method further comprises transmitting an indication of the sidelink resource to at least one of the first or the second terminal device.

In a third aspect, there is provided a method performed by a first terminal device. The method comprises receiving, from a network device, a distance threshold for a sidelink communication between the first terminal device and a second terminal device. The method also comprises obtaining, based on the distance threshold, a sidelink resource for the sidelink communication. The method further comprises performing the sidelink communication between the first and the second terminal devices using the sidelink resource.

In a fourth aspect, there is provided a method performed by a network device. The method comprises determining a distance threshold for a sidelink communication between a first terminal device and a second terminal device. The method also comprises transmitting the distance threshold to at least one of the first or the second terminal device.

In a fifth aspect, there is provided a first terminal device. The first terminal device comprises a processor and a memory storing instructions. The memory and the instructions are configured, with the processor, to cause the first terminal device to perform the method of any of the first and third aspects.

In a sixth aspect, there is provided a network device. The network device comprises a processor and a memory storing instructions. The memory and the instructions are configured, with the processor, to cause the network device to perform the method of any of the second and fourth aspects.

In a seventh aspect, there is provided a computer readable medium. The computer readable medium has instructions stored thereon. The instructions, when executed on at least one processor of a device, causing the device to perform the method of any of the first and third aspects.

In an eighth aspect, there is provided a computer readable medium. The computer readable medium has instructions stored thereon. The instructions, when executed on at least one processor of a device, causing the device to perform the method of any of the second and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIGS. 1A and 1B illustrate schematic diagrams of communication environments in which some embodiments of the present disclosure can be implemented, respectively;

FIG. 2 illustrates an example of a communication process performed among a network device, a first terminal device, and a second terminal device in accordance with some embodiments of the present disclosure;

FIG. 3 illustrates an example of a set of zones associated with a cell of a network device in accordance with some embodiments of the present disclosure;

FIG. 4 illustrates a current zone and a future zone associated with a first terminal device as well as a current zone and a future zone associated with a second terminal device in accordance with some embodiments of the present disclosure;

FIG. 5 illustrates an exemplary distance between a first terminal device and a second terminal device in accordance with some embodiments of the present disclosure;

FIG. 6 illustrates an example of a directional beam used for a sidelink communication between a first terminal device and a second terminal device in accordance with some embodiments of the present disclosure;

FIG. 7 illustrates an exemplary scenario in which two terminal devices in a sidelink communication are separately served by two different network devices in accordance with some embodiments of the present disclosure;

FIG. 8 illustrates an example of a communication process performed between a first network device and a second network device in accordance with some embodiments of the present disclosure;

FIG. 9 illustrates an example of a communication process performed among a network device, a first terminal device, and a second terminal device in accordance with some embodiments of the present disclosure;

FIG. 10 illustrates an example of a communication process performed among a network device, a first terminal device, and a second terminal device in accordance with some embodiments of the present disclosure;

FIG. 11 illustrates an example of a communication process performed between a network device and a first terminal device in accordance with some embodiments of the present disclosure;

FIG. 12 illustrates four terminal devices and their respective associated zones in accordance with some embodiments of the present disclosure;

FIG. 13 illustrates an example of a communication process performed among a first terminal device, a second terminal device, a third terminal device, and a fourth terminal device in accordance with some embodiments of the present disclosure;

FIG. 14 illustrates a flowchart of an example method for communication in accordance with some embodiments of the present disclosure;

FIG. 15 illustrates a flowchart of an example method for communication in accordance with some embodiments of the present disclosure;

FIG. 16 illustrates a flowchart of an example method for communication in accordance with some embodiments of the present disclosure;

FIG. 17 illustrates a flowchart of an example method for communication in accordance with some embodiments of the present disclosure; and

FIG. 18 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE”, may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As mentioned above, the standard of Vehicle-to-Everything (V2X) service or sidelink communication has been investigated in Releases 14 to 16 and has been developed further in Release 17. Specifically, Release 14 carries out a 4G Long Term Evolution (LTE) based V2X standard work (Phase 1), Release 15 involves a continuous LTE based V2X standard evolution (Phase 2), Release 16 provides a NR based V2X design (Phase 3), and Release 17 relates to a further NR based V2X design (Phase 4).

More particularly, Release 14 includes sidelink Semi-Persistent Scheduling (SPS) enhancement, congestion control, sidelink synchronization enhancement as well as simultaneous V2X operations over multiple carriers. Release 15 introduces new features into sidelink communications, including carrier aggregation, high order modulation, latency reduction, and feasibility study on both transmission diversity and short Transmission Time Interval (TTI) in sidelink communications.

In Release 16, NR V2X would support some advanced V2X services that identified by SA1, beyond services supported in LTE Rel-15 V2X, for example, Vehicles Platooning, Extended Sensors, Advanced Driving and Remote Driving. In this release, sidelink unicast communication, sidelink groupcast communication, and sidelink broadcast communication have been developed for V2X services, considering in-network coverage, out-of-network coverage, and partial network coverage. In addition, End-to-End (E2E) Quality of Service (QoS) management for V2X service has been investigated as well. Release 17 relates to further enhancement for power saving and enhanced reliability and reduced latency, including resource allocation and Discontinuous Reception (DRX).

Through a study and analysis of traditional sidelink communication solutions, the inventor(s) find that there are some technical problems which may degrade the performance of the sidelink communications. More particularly, the resource allocation mechanism described in the traditional sidelink communication solution (for example, the current 3GPP Sidelink/V2X work) may lead to a low resource utilization efficiency and a high interference level during sidelink communication.

In order to solve the above-identified technical problems, as well as potentially other technical problems found in the traditional solutions, embodiments of the present disclosure provide a solution (or an enhanced mechanism) for improving sidelink communications between terminal devices, especially for enhancing the resource utilization efficiency and reducing the potential interference level in sidelink communications.

In particular, in one aspect of a solution of the present disclosure, a first terminal device may transmit an assistance information to a network device that can be used by the network device to determine a sidelink resource to be used for a sidelink communication between the first terminal device and a second terminal device. After receiving the assistance information, the network device can determine the sidelink resource based on the assistance information. Then, the network device may transmit an indication of the sidelink resource to one or both of the first and second terminal devices. Upon receiving the indication, the first terminal device can perform the sidelink communication between the first and second terminal devices using the sidelink resource.

In another aspect of the solution of the present disclosure, a network device may determine a distance threshold for a sidelink communication between a first terminal device and a second terminal device. Then, the network device can transmit the distance threshold to one or both of the first and second terminal devices. Upon receiving the distance threshold, the first terminal device may obtain a sidelink resource to be used for the sidelink communication based on the distance threshold. Afterwards, the first terminal device can perform the sidelink communication with the second terminal device using the obtained sidelink resource. Through the solution of the present disclosure, the resource utilization efficiency can be enhanced or the interference level may be reduced in sidelink communications. Principles and implementations of embodiments of the present disclosure will be described in detail below with reference to the figures.

### Example Environment

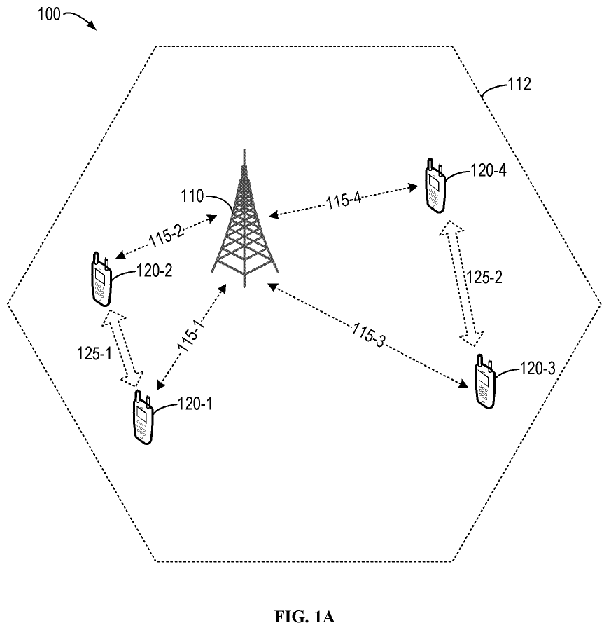

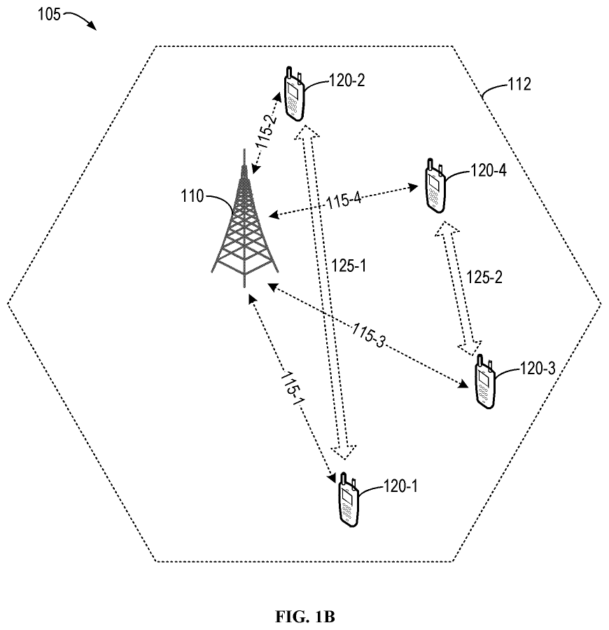

FIGS. 1A and 1B illustrate schematic diagrams of communication environments 100 and 105, respectively, in which some embodiments of the present disclosure can be implemented. As shown in FIG. 1A, the communication environment 100, which may also be referred to as a communication network 100 or a communication system 100, includes a network device 110 serving terminal devices 120-1 to 120-4 located in a cell 112 of the network device 110. For simplicity, the terminal devices 120-1 to 120-4 can be collectively referred to as terminal devices 120. To transmit data, control information, or the like, the terminal devices 120 can perform communication with the network device 110 via respective communication channels.

In particular, as illustrated in the exemplary scenario of FIG. 1A, a first terminal device 120-1 may communicate with the network device 110 via a communication channel 115-1, a second terminal device 120-2 may communicate with the network device 110 via a communication channel 115-2, a third terminal device 120-3 may communicate with the network device 110 via a communication channel 115-3, and a fourth terminal device 120-4 may communicate with the network device 110 via a communication channel 115-4. For simplicity, the communication channels 115-1 to 115-4 can be collectively be referred to as communication channels 115. When transmission of information occurs from the network device 110 to the terminal devices 120, the communication channels 115 may be referred to as downlink channels, whereas when transmission of information takes place from the terminal devices 120 to the network device 110, the communication channels 115 may alternatively be referred to as uplink channels.

In addition, the terminal devices 120 can perform sidelink communication, also referred to as device-to-device (D2D) communication, with each other via sidelink channels. For example, in the exemplary scenario of FIG. 1A, the first terminal device 120-1 may perform a first sidelink communication 125-1 with the second terminal device 120-2 via a first sidelink channel. More particularly, during the first sidelink communication 125-1, the first terminal device 120-1 can transmit a sidelink transmission to the second terminal device 120-2 or receive a sidelink transmission from the second terminal device 120-2. Similarly, the third terminal device 120-3 may perform a second sidelink communication 125-2 with the fourth terminal device 120-4 via a second sidelink channel. More particularly, during the second sidelink communication 125-2, the third terminal device 120-3 can transmit a sidelink transmission to the fourth terminal device 120-4 or receive a sidelink transmission from the fourth terminal device 120-4.

In the exemplary scenario of FIG. 1A, the pair of the first and second terminal devices 120-1 and 120-2 may be in a first local area within the cell 112, and the pair of the third and fourth terminal devices 120-3 and 120-4 may be in a second local area within the cell 112. In some embodiments, the first and second local areas can be considered as separated in distance. Accordingly, the first sidelink communication 125-1 and the second sidelink communication 125-2 can be performed using a same sidelink resource, thereby improving the resource utilization efficiency without causing significant interference onto each other.

As shown in FIG. 1B, the communication environment 105 is analogous to the communication environment 100 of FIG. 1A. The difference between the communication environment 105 and the communication environment 100 is that the first terminal device 120-1 and the second terminal device 120-2, as shown in FIG. 1B, are relatively far away from each other, and thus they cannot be considered to be in the same local area within the cell 112. Because the first sidelink communication 125-1 performed between the first and second terminal device 120-1 and 120-2 illustrated in FIG. 1B needs to be performed at a high power level due to the long distance between the first and second terminal devices 120-1 and 120-2, the first sidelink communication 125-1 can be deemed as a remote sidelink communication and may induce a significant level of interference in other sidelink communications performed in the cell 112, such as the second sidelink communication 125-2.

As used herein, the term “sidelink transmission” generally refers to any transmission performed from one terminal device to another terminal device via a sidelink channel that has been established between them. The sidelink transmission may be used for transmitting any data or control information associated with sidelink communications, for example, sidelink data, sidelink control information, sidelink feedback information, or the like. As used herein, the term “sidelink channel” may generally refer to any channel used for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

In some embodiments, the network device 110 may be absent in the communication environment 100 or 105. For example, one or more of the terminal devices 120 and other terminal devices (not shown) may be outside of the coverage range (namely, outside of the cell 112) of the network device 110. In such cases, only a sidelink communication may exist between one or more of the terminal devices 120 as well as possibly other terminal devices not shown in FIGS. 1A and 1B that are outside the cell 112.

Although the network device 110 and the terminal devices 120 are described in the communication environments 100 and 105 of FIGS. 1A and 1B, embodiments of the present disclosure may equally apply to any other suitable communication devices in communication with one another. That is, embodiments of the present disclosure are not limited to the exemplary scenarios of FIGS. 1A and 1B. In this regard, it is noted that although the network device 110 is schematically depicted as a base station and the terminal devices 120 are schematically depicted as mobile phones in FIGS. 1A and 1B, it is understood that these depictions are exemplary in nature without suggesting any limitation. In other embodiments, the network device 110 and the terminal devices 120 may be any other communication devices, for example, any other wireless communication devices.

In case terminal devices 120 are vehicle-mounted terminal devices, communication relate to them may be referred to as a V2X communication. More generally, although not shown in FIGS. 1A and 1B, the V2X communication related to the terminal devices 120 may comprise a communication channel between the first or second terminal devices 120-1 or 120-2, respectively, and any other communication device, including but not limited to, an infrastructure device, another vehicle-mounted terminal device, a device of a pedestrian, a roadside unit, or the like. Furthermore, although not shown, all the communication links as shown in FIGS. 1A and 1B may be via one or more relays.

It is to be understood that a particular number of various communication devices, a particular number of various communication links, a particular number of other elements and a particular shape of the cell 112 as shown in FIGS. 1A and 1B is for illustration purpose only without suggesting any limitations. The communication environment 100 may include any suitable number of communication devices, any suitable number of communication links, any suitable number of other elements and any suitable shape of the cell 112 adapted for implementing embodiments of the present disclosure. In addition, it should be appreciated that there may be various wireless as well as wireline communications (if needed) among all of the communication devices.

Communication in communication environments 100 or 105 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Process

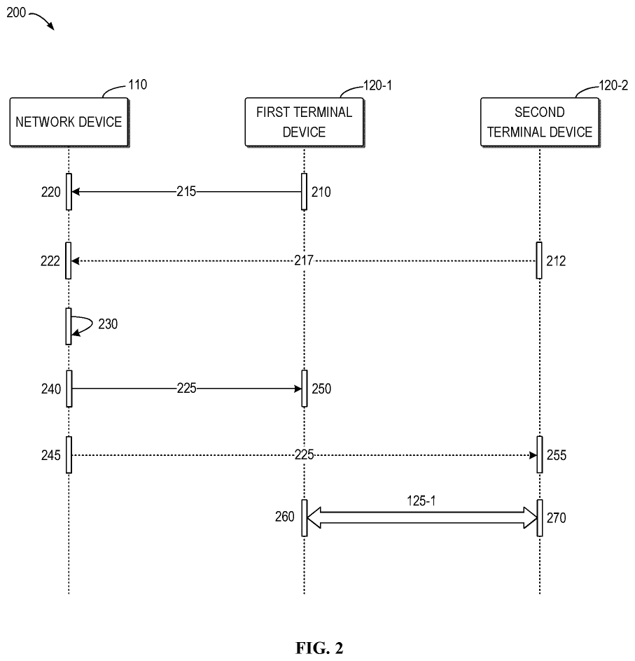

FIG. 2 illustrates an example of a communication process 200 performed among the network device 110, the first terminal device 120-1, and the second terminal device 120-2 in accordance with some embodiments of the present disclosure. It is to be understood that although the communication process 200 is depicted to be performed among the network device 110, the first terminal device 120-1 and the second terminal device 120-2, the communication process 200 can similarly be performed among the network device 110 and any other terminal devices of the terminal devices 120. For the purpose of discussion, the communication process 200 will be described with reference to FIGS. 1A and 1B. However, it would be appreciated that the communication process 200 may equally apply to other communication scenarios in which communication devices communicate with one another.

As shown in FIG. 2, in order to perform the first sidelink communication 125-1 between the first terminal device 120-1 and the second terminal device 120-2, the first terminal device 120-1 may transmit (210) assistance information 215 to the network device 110, and thus the network device 110 can receive (220) the assistance information 215 from the first terminal device 120-1. The assistance information 215 can be used by the network device 110 to determine (230) a sidelink resource for the first sidelink communication 125-1. For example, the assistant information 215 reported from the first terminal device 120-1 to the network device 110 can help the network device 110 in performing sidelink resource management and interference control for sidelink communication in the cell 112.

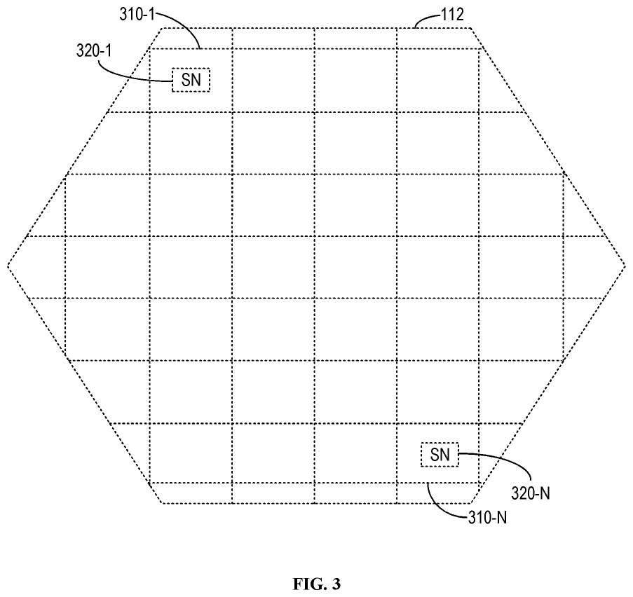

In general, the assistance information 215 may be any information that can assist the network device 110 in determining (230) a proper sidelink resource for the first sidelink communication 125-1. For example, the assistance information 215 may include position information of the first terminal device 120-1, distance information on distance between the first terminal device 120-1 and the second terminal device 120-2, beamforming information associated with the first sidelink communication 125-1, interference information on interference detected by the first terminal device 120-1, and so on. Based on such various kinds of information, the network device 110 can determine an optimized sidelink resource for the first sidelink communication 125-1 to enhance the resource utilization efficiency and reduce the interference level on the sidelink communication in the cell 112. Some embodiments will be further detailed hereinafter with reference to FIGS. 3 to 6.

In some embodiments, the second terminal device 120-2 can also transmit (212) an assistance information 217 to the network device 110 and thus, the network device 110 can also receive (222) the assistance information 217 from the second terminal device 120-2. The assistance information 217 can also be used by the network device 110 to determine (230) the sidelink resource for the first sidelink communication 125-1. For example, the assistant information 217 reported from the second terminal device 120-2 to the network device 110 can help the network device 110 in performing sidelink resource management and interference control for sidelink communication in the cell 112.

Similar to the assistance information 215, the assistance information 217 may be any information that can assist the network device 110 in determining (230) the proper sidelink resource for the first sidelink communication 125-1, such as position information of the second terminal device 120-2, distance information on distance between the first terminal device 120-1 and the second terminal device 120-2, beamforming information associated with the first sidelink communication 125-1, interference information on interference detected by the second terminal device 120-2, or the like.

After receiving (220) the assistance information 215, the network device 110 may determine (230) the sidelink resource for the first sidelink communication 125-1 based on the assistance information 215 received. In some embodiments, if the network device 110 also receives (222) the assistance information 217 from the second terminal device 120-2, the network device 110 can also use the assistance information 217 to determine (230) the sidelink resource for the first sidelink communication 125-1. More generally, in some embodiments, the network device 110 can receive assistance information from all the terminal devices associated with sidelink communications in the cell 112 and can determine sidelink resources for all requested sidelink communication based on the assistance information received.

In some embodiments, based on the received assistance information 215 and possibly other assistance information received from other terminal devices, the network device 110 can determine (230) the sidelink resource for the first sidelink communication 125-1 in such a way that the resource utilization efficiency can be enhanced and/or the interference level may be reduced for the sidelink communication in the cell 112, thereby improving the performance of the sidelink communication in the cell 112.

For example and with reference to FIG. 1A, based on the received assistance information 215 and possibly other assistance information received from other terminal devices, the network device 110 may determine that the pair of the first and second terminal devices 120-1 and 120-2 is in the first local area far away from the second local area in which the pair of the third and fourth terminal devices 120-3 and 120-4 are located. Thus, the network device 110 may determine that the first sidelink communication 125-1 and the second sidelink communication 125-2 will not cause significant interference onto each other even if the same sidelink resource were to be used. In this event, the network device 110 can determine (230) the same sidelink resource to be used for both the first sidelink communication 125-1 and the second sidelink communication 125-2, so as to increase the resource utilization efficiency of the sidelink communications in the cell 112 without inducing severe interference.

As another example and with reference to FIG. 1B, based on the assistance information 215 received and possibly other assistance information received from other terminal devices, the network device 110 may determine that the first sidelink communication 125-1 will not to induce significant interference onto the second sidelink communication 125-2 because the first sidelink communication 125-1 is to be performed using a directional beam. In this event, the network device 110 can determine (230) the same sidelink resource for both the first sidelink communication 125-1 and the second sidelink communication 125-2, so as to increase the resource utilization efficiency of the sidelink communications in the cell 112 without causing severe interference.

As a more general example, based on the assistance information 215 received and possibly other assistance information received from other terminal devices, the network device 110 may determine (230) a sidelink resource to be used by the first sidelink communication 125-1 in order to reduce an interference level caused by the first sidelink communication 125-1 to another sidelink communication in the cell 112, such as the second sidelink communication 125-2. Alternatively or additionally, the network device 110 may determine (230) a sidelink resource for the first sidelink communication 125-1 to reduce interference caused by another sidelink communication in the cell 112 (such as the second sidelink communication 125-2) to the first sidelink communication 125-1. Therefore, potential high interference levels observed on a sidelink communication in the cell 112 can be advantageously avoided, significantly reduced or eliminated.

Subsequent to determining (230) a sidelink resource for the first sidelink communication 125-1, the network device 110 may transmit (240) an indication 225 of the sidelink resource to the first terminal device 120-1, so that the first terminal device 120-1 can use the sidelink resource for the first sidelink communication 125-1. For example, in this case the first terminal device 120-1 is a transmitting device in the first sidelink communication 125-1. In some embodiments, the network device 110 may transmit (245) the indication 225 to the second terminal device 120-2, so that the second terminal device 120-2 can know the sidelink resource to be used for the first sidelink communication 125-1. For example, this may the case that the second terminal device 120-2 is the transmitting device in the first sidelink communication 125-1. However, it is noted that the network device 110 can transmit the indication 225 to either one or both of the first terminal device 120-1 and the second terminal device 120-2, no matter which terminal device is the transmitting device.

Upon receiving (250) the indication 225 from the network device 110, the first terminal device 120-1 may perform (260) or initiate the first sidelink communication 125-1 between the first terminal device 120-1 and the second terminal device 120-2 using the sidelink resource indicated by the network device 110. For example, if the first terminal device 120-1 is a transmitting device in the first sidelink communication 125-1, the first terminal device 120-1 can perform a sidelink transmission to the second terminal device 120-2 using the sidelink resource received. Alternatively, if the first terminal device 120-1 is a receiving device in the first sidelink communication 125-1, the first terminal device 120-1 can receive a sidelink transmission from the second terminal device 120-2 using the sidelink resource. Since the sidelink resource is an optimized sidelink resource determined by the network device 110 based on the assistance information 215 received and possibly other assistance information received from other terminal devices, the resource utilization efficiency and the interference level in the sidelink communication in the cell 112 can be improved by performing the first sidelink communication 125-1 using the sidelink resource.

From the perspective of the second terminal device 120-2, upon receiving (255) the indication 225 from the network device 110, the second terminal device 120-2 may perform (270) the first sidelink communication 125-1 using a sidelink resource indicated by the network device 110. For example, if the second terminal device 120-2 is the transmitting device in the first sidelink communication 125-1, then the second terminal device 120-2 can perform a sidelink transmission to the first terminal device 120-1 using the sidelink resource indicated by the network device 110. Alternatively, if the second terminal device 120-2 is the receiving device in the first sidelink communication 125-1, then the second terminal device 120-2 can receive a sidelink transmission from the first terminal device 120-1 using the sidelink resource.

Through the communication process 200, the assistance information 215 and possibly the assistance information 217 can be provided by the first terminal device 120-1 and the second terminal device 120-2 to the network device 110. Thus, based on the received assistance information 215, the received assistance information 217, and/or possibly other assistance information received from other terminal devices, the network device 110 can determine an appropriate sidelink resource to be used for the first sidelink communication 125-1 so as to enhance a resource utilization efficiency and reduce an interference level in the sidelink communications in the cell 112, thereby improving the performance of the sidelink communications.

As mentioned above, the assistance information 215 provided by the first terminal device 120-1 may include various kinds of information that can assist the network device 110 in determining (230) a proper sidelink resource for the first sidelink communication 125-1. In some embodiments, the assistance information 215 may include position information on the position of the first sidelink communication 125-1.

In order to facilitate allocation of sidelink resources by the network device 110 based on the indicated position of various terminal devices, a zone concept may be defined for efficient resource usage and interference handling. For example, a geographical area of the cell 112 may be divided into multiple, for example rectangular, zones which can be communicated to terminal devices by higher layer signalling. In some embodiments, each zone can be configured with a serial number (also termed as a zone ID) and may be associated with a specific resource pool for sidelink communications. Thus, when a terminal device is located in a specific zone, the network device 110 can select a sidelink resource from the associated resource pool and allocate the selected sidelink resource to the terminal device for performing sidelink communications. Therefore, some embodiments of the present disclosure can provide a zone-based solution for enhancing sidelink communications.

In some embodiments, the network device 110 can use an SL-ZoneConfig information element in the higher layer signalling to configure the zones and inform the terminal devices 120. For example, the SL-ZoneConfig information element can include various fields, such as, a zoneLength field, a zoneWidth field, a zoneIdLongiMod field, a zoneIdLatiMod field, or the like. The zoneLength field can indicate the length of each geographic zone, for example, a value of “m5” may correspond to 5 meters and a value of “m10” may correspond to 10 meters and so on. The zoneWidth field can indicate the width of each geographic zone, for example, a value of “m5” may correspond to 5 meters and a value of m10 corresponds to 10 meters and so on. The zoneIdLongiMod field may indicate a total number of zones configured with respect to longitude. The zoneIdLatiMod field may indicate a total number of zones configured with respect to latitude.

FIG. 3 illustrates an example of a set of zones 310-1 to 310-N (also collectively referred to as a set of zone 310) associated with the cell 112 of the network device 110 in accordance with some embodiments of the present disclosure. As shown in FIG. 3, the geographical area of the cell 112 can be divided into the set of zones 310 including a zone 310-1 to a zone 310-N. The set of zones 310 can be configured with respective serial numbers 320, which are shown as “SN” in FIG. 3. For example, the zone 310-1 may have a serial number 320-1 and the zone 310-N may have a serial number 320-N. The serial numbers 320 can be used for identifying individual zones and can also be referred to as zone IDs 320 as used herein. It is to be understood that the particular number, the particular size and the particular shape of the zones 310 as shown in FIG. 3 are only for the purpose of illustration without suggesting any limitations. In other embodiments, the cell 112 may include any suitable number of zones 310, the zones 310 may have other suitable sizes or shapes, and different zones may have different sizes or shapes.

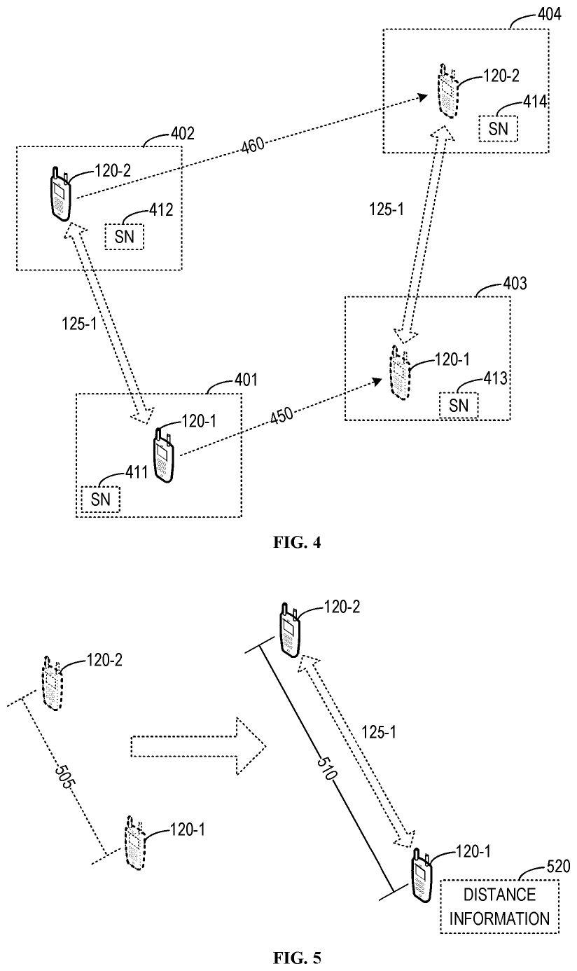

In the case that the cell 112 is divided into the set of zones 310, position information of the first terminal device 120-1 may be provided to the network device 110 in the form of a serial number of a zone associated with the first terminal device 120-1. Upon receiving the serial number of the zone associated with the first terminal device 120-1 and possibly other serial numbers reported by other terminal devices, the network device 110 can determine a sidelink resource for the first sidelink communication 125-1 based on the serial number of the zone and possibly other serial numbers. For example, the serial numbers of the zones associated with the terminal devices 120 in the cell 112 can be reported to the network device 110, then those serial numbers can be used by the network device 110 to judge whether the current resource allocation for related zones is allowed or not. Some embodiments will be further detailed below with reference to FIG. 4.

FIG. 4 illustrates a current zone 401 and a future zone 403 associated with the first terminal device 120-1 as well as a current zone 402 and a future zone 404 associated with the second terminal device 120-2 in accordance with some embodiments of the present disclosure. In the exemplary scenario of FIG. 4, it is assumed that the first terminal device 120-1 is currently located in the zone 401 with a serial number 411 and the second terminal device 120-2 is currently located in the zone 402 with a serial number 412. Therefore, the zone 401 can be referred to as the current zone 401 of the first terminal device 120-1 and the zone 402 can be referred to as the current zone 402 of the second terminal device 120-2.

As also shown in FIG. 4, it is assumed that the first terminal device 120-1 can, for example, predict zone 403 having a serial number 413 to be its location in a near future. For example, prediction of the zone 403 may be based on an information related to the movement 450 of the first terminal device 120-1. Analogously, the second terminal device 120-2 can, for example, predict that zone 404 having a serial number 414 may be its location in a near future. In some embodiments, prediction of the zone 404 may be based on an information related to a movement 460 of the second terminal device 120-2. Therefore, the zone 403 can be referred to as the future zone 403 of the first terminal device 120-1 and the zone 404 can be referred to as the future zone 404 of the second terminal device 120-2.

With reference to both FIGS. 2 and 4, in the exemplary scenario of FIG. 4, the assistance information 215 transmitted (210) by the first terminal device 120-1 to the network device 110 may include serial numbers of zones associated with the first terminal device 120-1. More particularly, when transmitting (210) the assistance information 215, the first terminal device 120-1 may transmit (210) the serial number 411 of the current zone 401 it is located in to the network device 110. Alternatively or additionally, the first terminal device 120-1 may transmit (210) the serial number 413 of the future zone 403 it will be located in the near future to the network device 110. On the receiving side of the assistance information 215, the network device 110 may receive (220) the serial number 411 of the current zone 401 the first terminal device 120-1 is located, the serial number 413 of the future zone 403 the first terminal device 120-1 will be located in the near future, or both of them.

Likewise, the assistance information 217 transmitted (212) by the second terminal device 120-2 to the network device 110 may include serial numbers of zones associated with locations of the second terminal device 120-2. Accordingly, in transmitting (212) the assistance information 217, the second terminal device 120-2 may transmit (212) the serial number 412 of the current zone 402 it is located in to the network device 110. Alternatively or additionally, the second terminal device 120-2 may transmit (212) the serial number 414 of the future zone 404 it will be in the near future to the network device 110. On the receiving side of the assistance information 217, the network device 110 may receive (222) the serial number 412 of the current zone 402 of the second terminal device 120-2, the serial number 414 of the future zone 404 of the second terminal device 120-2, or both of them.

Based on the zone information associated with the locations of the first terminal device 120-1 and the second terminal device 120-2, the network device 110 may determine (230) a sidelink resource for the first sidelink communication 125-1 by judging whether the current resource allocation for the reported zones is allowed or not. In this way, the network device 110 can select an appropriate sidelink resource for the first sidelink communication 125-1, so as to increase resource utilization efficiency without inducing significant interference in the sidelink communications in the cell 112 and thereby improving the performance of the sidelink communications in the cell 112.

In some embodiments, instead of separately transmitting zone information by the first terminal device 120-1 and the second terminal device 120-2 to the network device 110, the transmitting device in the first sidelink communication 125-1 can transmit zone information of both the first terminal device 120-1 and the second terminal device 120-2 to the network device 110. For example, if the first terminal device 120-1 is the transmitting device, the zone information of the second terminal device 120-2 can be provided to the first terminal device 120-1 through a synchronization process or in any other suitable manner. In this way, the second terminal device 120-2 does not need to transmit the zone information to the network device 110, thereby saving transmission resource that would have been allocated for individually transmitting the zone information of the second terminal device 120-2.

More particularly, when transmitting (210) the assistance information 215 to the network device 110, the first terminal device 120-1 can transmit (210) the serial number 412 of the zone 402 and/or the serial number 414 of the zone 404 associated with the second terminal device 120-2, in addition to the serial number 411 of the zone 401 and/or the serial number 413 of the zone 403 associated with the first terminal device 120-1. On the receiving side of the assistance information 215, the network device 110 may receive (220) zone information of both the first terminal device 120-1 and the second terminal device 120-2 from the first terminal device 120-1, for example, the serial number 411 of the zone 401 and/or the serial number 413 of the zone 403 associated with the first terminal device 120-1 as well as the serial number 412 of the zone 402 and/or the serial number 414 of the zone 404 associated with the second terminal device 120-2.

In some embodiments, the zone information of the first terminal device 120-1 may be transmitted to the network device 110 based on a certain condition. More generally, each terminal device associated with a sidelink communication can report its own zone information to the network device 110 conditionally. As an example condition, the transmission of the zone information can be in response to a request from the network device 110. In particular, the network device 110 may transmit a request to the first terminal device 120-1 for requesting a zone information from the first terminal device 120-1, such as one or more of the serial numbers 411-414 of the zones 401-404. Upon receiving the request from the network device 110, the first terminal device 120-1 may transmit the zone information associated with the first sidelink communication 125-1 to the network device 110. As such, the zone information can be reported to the network device 110 only if the network device 110 needs the zone information, thereby reducing signalling overhead for transmitting unnecessary zone information.

As another example condition, transmission of a zone information can be based on a difference between a current serial number and a previous serial number greater than a predefined difference threshold. In other words, with reference to FIG. 4, if the first terminal device 120-1 determines that a difference between the serial number 401 and a previously reported serial number is greater than the difference threshold, then the first terminal device 120-1 may transmit the zone information to the network device 110. In this way, the zone information can be reported to the network device 110 only if the position of the first terminal device 120-1 changes significantly, thereby ensuring the necessity of reporting the zone information and reducing signalling overhead associated with transmitting an unnecessary zone information. Further, in some embodiments, the first terminal device 120-1 is the transmitting device in the first sidelink communication 125-1 and transmits zone information of both the first terminal device 12-1 and the second terminal device 120-2 to the network device 110. In these embodiments, the first terminal device 120-1 can transmit the zone information in response to a difference between current and previous serial numbers greater than the difference threshold. In some embodiments, the difference threshold can be configured or preconfigured by the network device 110 according to specific communication environments or performance requirements.

As a further example condition, the transmission of the zone information can be based on the number of changes of a serial number greater than a predefined number threshold. For example, if the first terminal device 120-1 determines that the number of changes of the serial number associate with the current zone is greater than the number threshold since a previously reported serial number, then the first terminal device 120-1 may transmit the zone information to the network device 110. As such, the zone information can be reported to the network device 110 only if the first terminal device 120-1 has moved through an enough number of zones, thereby ensuring the necessity of reporting the zone information and reducing signalling overhead for transmitting unnecessary zone information. Further, in some embodiments, the first terminal device 120-1 is the transmitting device in the first sidelink communication 125-1 and transmits the zone information of both the first terminal device 12-1 and the second terminal device 120-2 to the network device 110. In these embodiments, the first terminal device 120-1 can transmit the zone information in response to the number of changes of a serial number greater than the predefined number threshold. In some embodiments, the number threshold can be configured or preconfigured by the network device 110 according to specific communication environments or performance requirements.

In addition or as an alternative to the position information (such as zone information), the assistance information 215 can include distance information between the first terminal device 120-1 and the second terminal device 120-2. In some embodiments, the distance information may be needed in ranging-based services, which are services utilizing the distance (and may be the direction) between two UEs, for example, the UE discovery service for picture sharing between friends.

Typically ranging does not require the network device 110 to deploy positioning infrastructures or provide positioning services, as it is directly done between two or more UEs involved. Ranging-based services are different from positioning services which can be sensitive due to privacy or regulation concerns. Ranging-based services are becoming popular in a variety of verticals such as consumer, smart home, smart city, smart transportation and industry.

In addition to the need in the ranging-based services, the distance information between the first terminal device 120-1 and the second terminal device 120-2 may also be used by the network device 110 to determine whether the first sidelink communication 125-1 is a remote sidelink communication. If the first sidelink communication 125-1 is a remote sidelink communication, then the network device 110 can optimize the selection of the sidelink resource for the first sidelink communication 125-1, so as to avoid the potential severe interference caused by the remote sidelink communication.

Therefore, in some embodiments, the assistance information 215 provided by the first terminal device 120-1 to the network device 110 may contain the distance information (also termed as ranging information) between the first terminal device 120-1 and the second terminal device 120-2, and thus the network device 110 can improving the first sidelink communication 125-1 based on the distance information, thereby providing a ranging-based solution for enhancing sidelink communications. In these embodiments, it is assumed that a position of a terminal device can be determined by the terminal device and can be provided to another terminal device. Therefore, the position information of terminal devices can be known among the terminal devices, and then the inter-UE distance can be easily determined. More specifically, the position information of a terminal device can be derived via a Global Navigation Satellite System (GNSS)/Global Positioning System (GPS) scheme or a network based positioning scheme, for example, the Observed Time Difference of Arrival (OTDOA) scheme.

FIG. 5 illustrates an exemplary distance 510 between the first terminal device 120-1 and the second terminal device 120-2 in accordance with some embodiments of the present disclosure. In the exemplary scenario of FIG. 5, it is assumed that the first terminal device 120-1 and the second terminal device 120-2 have positioning capability, and either one of the two terminal devices can provide its position to the other one of the two terminal devices. Thus, one or both of the first terminal device 120-1 and the second terminal device 120-2 can determine the distance 510 between the first terminal device 120-1 and the second terminal device 120-2.

With reference to both FIGS. 2 and 5, the assistance information 215 transmitted (210) by the first terminal device 120-1 to the network device 110 may include distance information 520 indicating the distance 510 between the first terminal device 120-1 and the second terminal device 120-2. Accordingly, when transmitting (210) the assistance information 215 to the network device 110, the first terminal device 120-1 may transmit (210) the distance information 520 to the network device 110, and the network device 110 may receive (220) the distance information 520 from the first terminal device 120-1.

In this way, the network device 110 can select an appropriate sidelink resource for the first sidelink communication 125-1 based on the distance 510, so as to increase the resource utilization efficiency without inducing significant interference in the sidelink communications in the cell 112, thereby improving the performance of the sidelink communications. In addition, the network device 110 can improve the ranging-based services based on the distance information 520. In some embodiments, the transmitting device of the first sidelink communication 125-1 can report the distance information 520 to the network device 110. However, it is to be understood that the distance information 520 may alternatively reported by the receiving device of the first sidelink communication 125-1, or by both the transmitting and receiving devices.

In some embodiments, the distance information 520 may contain a value of the distance 510. Such distance information 520 can be termed as absolute ranging information, which may be an absolute distance value in meters or kilometres. As such, the network device 110 can obtain the exact value of the distance 510, thereby allowing a more precise calculation based on the value of the distance 510. Alternatively, the distance information 520 can contain an indication of a value range including the value of the distance 510. Such distance information 520 may be termed as relative communication ranging information. As such, the signaling overhead for reporting the distance 510 can be reduced. For example, the relative communication ranging can be a coded value of a number of bits, such as 2 bits for indicating 4-level relative distances as follows: “00” may represent 0-5 meters, “01” may represent 6-10 meters, “10” may represent 1115 meters, and “11” may represent 16-20 meters. It is to be appreciated that 3 bits for indicating 8-level relative distances or any other number of bits for indicating the relative distances are also possible. Further, it is to be understood that the specific values as listed above are exemplary in nature without suggesting any limitation.

In some embodiments, the distance information 520 may be transmitted to the network device 110 based on a certain condition. For example, if the change in the distance between the first and second terminal devices 120-1 and 120-2 is greater a predefined distance difference threshold, then the new distance can be reported and authorized by the network device 110. More specifically, with reference to FIG. 5, the first terminal device 120-1 may determine the current distance 510 between the first and second terminal devices 120-1 and 120-2, and can also determine the previous distance 505 between the first and second terminal devices 120-1 and 120-2 reported to the network device 110. If the first terminal device 120-1 determines that a difference between the current distance 510 and the previous distance 505 is greater than the distance difference threshold, then the first terminal device 120-1 may transmit the distance information 520 to the network device 110. As such, the distance information 520 can be reported to the network device 110 only if the distance changes significantly, thereby ensuring the necessity of reporting the distance information 520 and reducing signaling overhead for transmitting unnecessary distance information. In some embodiments, the distance difference threshold can be configured or preconfigured by the network device 110 according to specific communication environments or performance requirements.

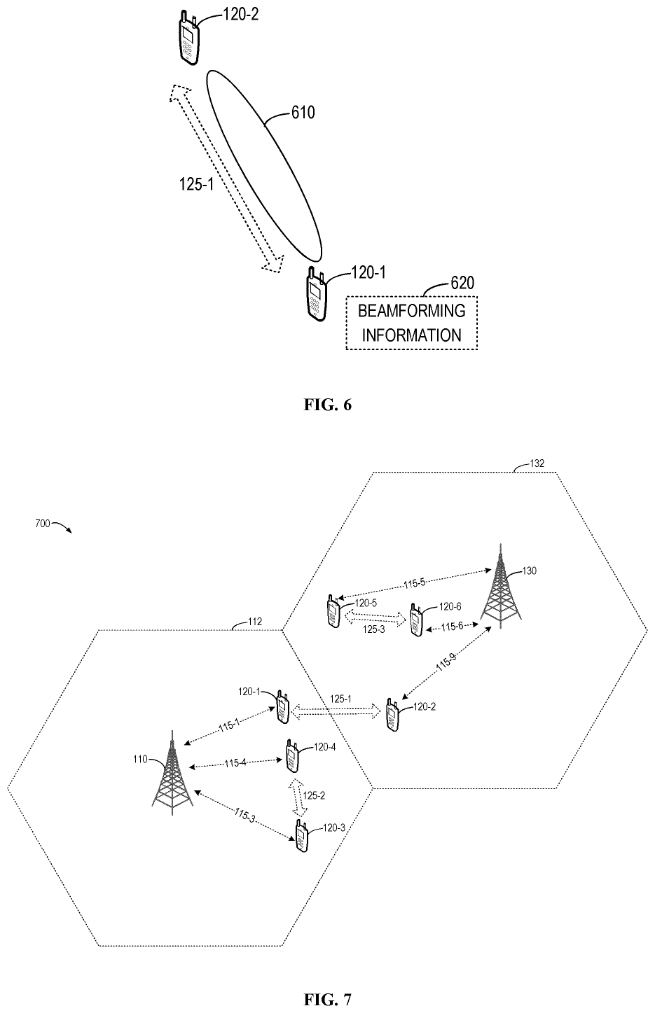

In addition or as an alternative to the position information (such as zone information) and the distance information 520, the assistance information 215 provided by the first terminal device 120-1 to the network device 110 can include beamforming information related to the first sidelink communication 125-1. For example, if a directional antenna or beamforming is to be used in the first sidelink communication 125-1, for example, in the Frequency Range 2 (FR2) as defined in the 3GPP specifications, then the antenna direction and relevant antenna parameters may be reported to the network device 110. Some embodiments will be detailed below with reference to FIG. 6.

FIG. 6 illustrates an example of a directional beam 610 used for the first sidelink communication 125-1 between the first terminal device 120-1 and the second terminal device 120-2 in accordance with some embodiments of the present disclosure. In the exemplary scenario of FIG. 6, it is assumed that the first terminal device 120-1 is to transmit a sidelink transmission using the directional beam 610 and the first terminal device 120-1 can generate beamforming information 620 to indicate the directional beam 610. For example, the beamforming information 620 may include information related to the directional antenna, antenna direction information, beamforming parameters, or other antenna parameters.

Accordingly, with reference to both FIGS. 2 and 6, in the exemplary scenario of FIG. 6, the assistance information 215 transmitted (210) by the first terminal device 120-1 to the network device 110 may include the beamforming information 620 on the directional beam 610 to be used for the first sidelink communication 125-1. Accordingly, upon receiving the beamforming information 620, the network device 110 will know that the directional beam 610 is to be used for performing the first sidelink communication 125-1. Due to the directional beam 610, the first sidelink communication 125-1 is not to induce significant interference onto other sidelink communications in the cell 112, for example, the second sidelink communication 125-2, even if the first sidelink communication 125-1 is a remote sidelink communication. Therefore, the network device 110 can allocate the same sidelink resource to both the first sidelink communication 125-1 and the second sidelink communication 125-2.

In this way, the network device 110 can select an appropriate sidelink resource for the first sidelink communication 125-1 based on the received beamforming information 620, so as to increase the resource utilization efficiency without inducing significant interference in the sidelink communications in the cell 112, thereby improving the performance of the sidelink communications. In contrast, if the network device 110 does not have the beamforming information 620, the sidelink resource for the first sidelink communication 125-1 cannot be reused for the second sidelink communication 125-2, even if a directional antenna or beamforming mechanism is used for the first sidelink communication 125-1.

More particularly, based on the beamforming information 620, the network device 110 may determine that interference onto be caused by the first sidelink communication 125-1 to the second sidelink communication 125-2 is below an interference threshold. In this event, when determining (230) the sidelink resource for the first sidelink communication 125-1, the network device 110 may determine (230) the sidelink resource for both the first sidelink communication 125-1 and the second sidelink communication 125-2, so as to enhance the resource utilization efficiency without inducing significant interference. In some embodiments, the interference threshold can be configured or preconfigured by the network device 110 according to specific communication environments or performance requirements.

Hereinbefore, some embodiments are described in which the first terminal device 120-1 and the second terminal device 120-2 associated with the first sidelink communication 125-1 are both served by the network device 110. Hereinafter, some other embodiments will be described with reference to FIG. 7, in which the first terminal device 120-1 and the second terminal device 120-2 are located in different cells of different network devices and are served by the different network devices, respectively.

FIG. 7 illustrates an exemplary scenario 700 in which the first terminal device 120-1 and the second terminal device 120-2 associated with the first sidelink communication 125-1 are separately served by two different network devices in accordance with some embodiments of the present disclosure. As shown in FIG. 7, the communication environment 700 includes the network device 110 (also termed as a first network device 110) serving the terminal devices 120-1, 120-3 and 120-4 located in the cell 112 of the first network device 110. In addition, the communication environment 700 includes a second network device 130 serving terminal devices 120-2, 120-5 and 120-6 located in a cell 132 of the second network device 130. In some embodiments, the second network device 130 is a neighbouring network device of the first network device 110, and thus the cells 112 and 132 are neighbouring cells.

In the exemplary scenario of FIG. 7, the first terminal device 120-1 may communicate with the first network device 110 via the communication channel 115-1, the third terminal device 120-3 may communicate with the first network device 110 via the communication channel 115-3, and the fourth terminal device 120-4 may communicate with the first network device 110 via the communication channel 115-4. Similarly, the second terminal device 120-2 may communicate with the second network device 130 via a communication channel 115-9, a fifth terminal device 120-5 may communicate with the second network device 130 via a communication channel 115-5, and a sixth terminal device 120-6 may communicate with the second network device 130 via a communication channel 115-6.

Additionally, in the exemplary scenario of FIG. 7, the first terminal device 120-1 may perform the first sidelink communication 125-1 with the second terminal device 120-2. Similarly, the third terminal device 120-3 may perform the second sidelink communication 125-2 with the fourth terminal device 120-4, and the fifth terminal device 120-5 may perform a third sidelink communication 125-3 with the sixth terminal device 120-6. It can be seen from FIG. 7 that the second terminal device 120-2 is served by the second network device 130 instead of the first network device 110 compared to FIGS. 1A and 1B.

In this event, there may not be a communication channel between the first network device 110 and the second terminal device 120-2 and there may not be a communication channel between the second network device 120 and the first terminal device 120-1. Accordingly, the assistance information 217 provided by the second terminal device 120-2 cannot be directly transmitted to the first network device 110. Likewise, the assistance information 215 provided by the first terminal device 120-1 cannot be directly transmitted to the second network device 130. In some embodiments, the first network device 110 can obtain the assistance information 217 through a communication with the second network device 130, for example, via an X2 or Xn interface. In a similar way, the second network device 130 can also obtain the assistance information 215 via the X2 or Xn interface.

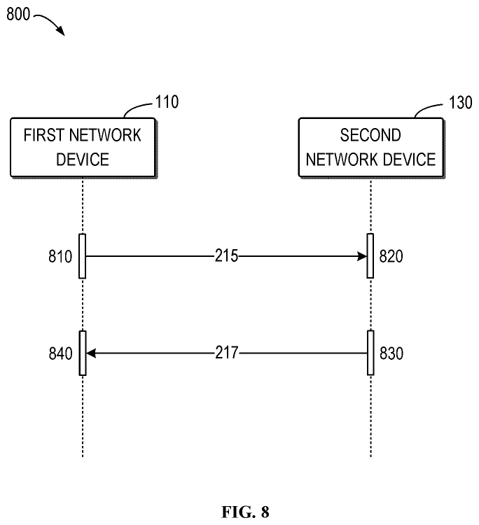

More particularly, the position information (such as zone information), the distance information, the beamforming information, and/or sensed interference information provided by the first and second terminal devices 120-1 and 120-2 may be exchanged between the first and second network devices 110 and 130 via the X2 or Xn interface. Otherwise, if there is no such an inter-gNB information exchange between the first and second network devices 110 and 130, the first sidelink communication 125-1 may interfere with the second terminal device 120-2 and/or the third sidelink communication 125-3. Some embodiments of the information exchange between the first and second network devices 110 and 130 will be further detailed below with reference to FIG. 8.

FIG. 8 illustrates an example of a communication process 800 performed between the first network device 110 and the second network device 130 in accordance with some embodiments of the present disclosure. For the purpose of discussion, the communication process 800 will be described with reference to FIG. 7. However, it would be appreciated that the communication process 800 may equally apply to other communication scenarios in which communication devices communicate with one another.

As shown in FIG. 8, the first network device 110 may transmit (810) assistance information 215 to the second network device 130, and thus the second network device 130 can receive (820) the assistance information 215 from the first network device 110. Accordingly, if the second terminal device 120-2 is the transmitting device in the first sidelink communication 125-1, the second network device 130 may determine the sidelink resource for the first sidelink communication 125-1 based on the assistance information 215 and assistance information 217. Also, based on the assistance information 215 and the assistance information 217, the second network device 130 can determine sidelink resources for other sidelink communications in the cell 132, for example, the third sidelink communication 125-3. In this way, resource utilization efficiency can be enhanced, and interference can be reduced in the sidelink communications in the cell 132, thereby improving the performance of the sidelink communications in the cell 132.

Likewise, the second network device 130 can transmit (830) the second assistance information 217 to the first network device 110. The assistance information 217 may be transmitted by the second terminal device 120-2 to the second network device 130. Upon receiving (840) the assistance information 217 from the second network device 130, the first network device 110 may determine the sidelink resource for the first sidelink communication 125-1 based on the assistance information 215 and the assistance information 217, if the first terminal device 120-1 is the transmitting device in the first sidelink communication 125-1. Also, based on the assistance information 215 and the assistance information 217, the first network device 110 can determine sidelink resources for other sidelink communications in the cell 112, for example, the second sidelink communication 125-2. In this way, resource utilization efficiency can be enhanced and the interference can be reduced in the sidelink communications in the cell 112, thereby improving the performance of the sidelink communications in the cell 112.

Through the communication process 800, the assistance information 215 and the assistance information 217 can be exchanged between the first and second network devices 110 and 130. Thus, based on the assistance information 215 and the assistance information 217, the first network device 110 or the second network device 130 can determine an appropriate sidelink resource for the first sidelink communication 125-1 between the first terminal device 120-1 and the second terminal device 120-2, so as to enhance resource utilization efficiency and reduce interference in sidelink communications in the cell 112 and in the cell 132.

Hereinbefore, some embodiments are described in which the assistance information is provided to the network device 110 and the network device 110 determines the sidelink resource for the first sidelink communication 125-1. However, if the first and second terminal devices 120-1 and 120-2 perform sidelink communications in the UE autonomous operation mode (Mode 2) in which a sidelink resource can be selected by a transmitting device in a sidelink communication, then the network device 110 may not determine the sidelink resource for the first sidelink communication 125-1. In this event, with reference to FIGS. 1A and 1B, the first sidelink communication 125-1 may interfere with the second sidelink communication 125-2 because the first and second terminal devices 120-1 and 120-2 may be unable to detect signals from the third and fourth terminal devices 120-3 and 120-4 due to the hidden node problem.

To at least solve this issue, some embodiments will be described hereinafter in which the network device 110 can configure a distance threshold for sidelink communications between terminal devices served by the network device 110, in order to avoid destructive interference caused by a sidelink communication with a long communication distance, also termed as a remote sidelink communication. If a sidelink communication has a communication distance greater than the distance threshold, then the sidelink communication may be considered as a remote sidelink communication. Normally, a transmitting device in the remote sidelink communication may need to transmit signals of high power due to the long distance between the terminal devices, and thus can induce significant interference onto other sidelink communication channels.

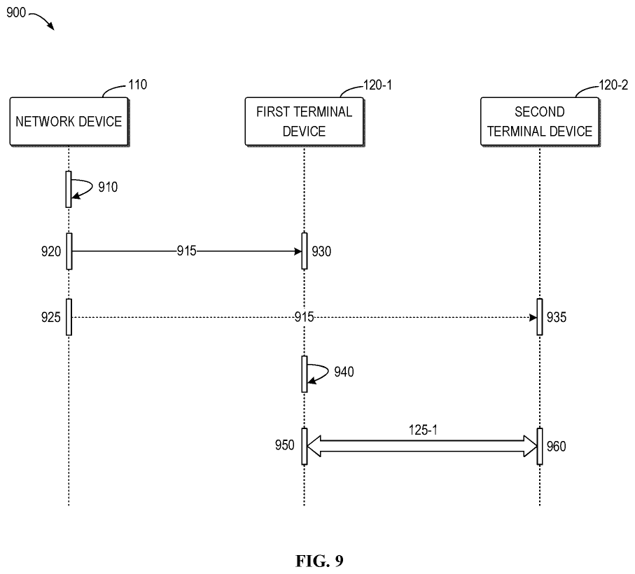

Accordingly, if the distance between the first terminal device 120-1 and the second terminal device 120-2 is greater than the distance threshold configured by the network device 110, the first terminal device 120-1 may need to obtain a sidelink resource for the first sidelink communication 125-1 in such a way that the potential severe interference onto other sidelink communication channels can be avoided. Some embodiments will be detailed below with reference to FIG. 9.

FIG. 9 illustrates an example of a communication process 900 performed among the network device 110, the first terminal device 120-1, and the second terminal device 120-2 in accordance with some embodiments of the present disclosure. It is to be understood that although the communication process 900 is depicted to be performed among the network device 110, the first terminal device 120-1 and the second terminal device 120-2, the communication process 900 can similarly be performed among the network device 110 and any other terminal devices of the terminal devices 120. For the purpose of discussion, the communication process 900 will be described with reference to FIGS. 1A and 1B. However, it would be appreciated that the communication process 900 may equally apply to other communication scenarios in which communication devices communicate with one another.

As shown in FIG. 9, the network device 110 may determine (910) a distance threshold 915 (also termed as a range limit) to be applied for the first sidelink communication 125-1 between the first terminal device 120-1 and the second terminal device 120-2. As indicated, the distance threshold 915 may be regarded as a criterion for determining whether a sidelink communication is a remote sidelink communication that may induce significant interference on other sidelink communication channels. In general, the distance threshold 915 can be determined based on various factors (or metrics) related to the sidelink communications in the cell 112. In some embodiments, the network device 110 may determine (910) the distance threshold 915 based on a traffic type of the first sidelink communication 125-1.

In this way, the network device 110 can determine a more proper and targeted distance threshold 915 for the first sidelink communication 125-1. For example, if the first sidelink communication 125-1 has a traffic type that needs high reliability or low latency, then the distance threshold 915 can be configured to be a relatively small value, for example, the allowed inter-distance between two sidelink devices is short, so as to ensure the high reliability and the low latency of the first sidelink communication 125-1. In contrast, if the first sidelink communication 125-1 has a traffic type that does not need high reliability or low latency, then the distance threshold 915 can be configured to be a relatively large value, for example, the allowed inter-distance between two sidelink devices is long, so as to reduce the potential interference onto be caused by the first sidelink communication 125-1.

Alternatively or additionally, the network device 110 may determine (910) the distance threshold 915 based on locations of the first terminal device 120-1 and the second terminal device 120-2. For example, if either one of the first terminal device 120-1 and the second terminal device 120-2 or both of them are in an area of high sidelink communication traffic, then the distance threshold 915 can be configured to be relatively low, so as to reduce the potential interference onto be caused by the first sidelink communication 125-1. In contrast, if the first terminal device 120-1 and the second terminal device 120-2 are located in an area of low sidelink communication traffic, then the distance threshold 915 can be configured to be relatively high, so as to enhance the resource utilization efficiency.

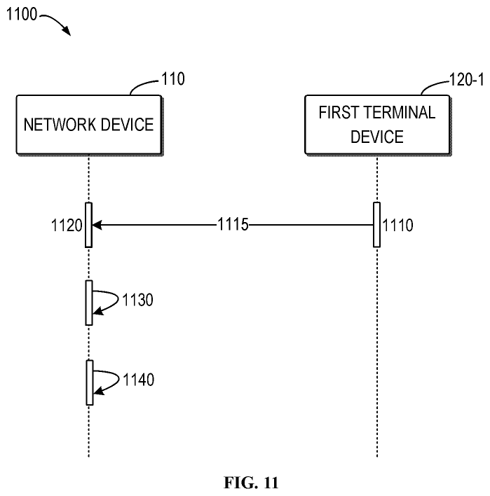

In some other embodiments, the network device 110 may determine (910) the distance threshold 915 based on interference information reported by the first terminal device 120-1. The interference information may indicate the interference detected by the first terminal device 120-1 and can reflect the sidelink communication load in the cell 112. Such embodiments will be further detailed hereinafter with reference to FIG. 11.

In some embodiments, the distance threshold 915 can be specific to an area including a set of zones or zone cluster. For example, a first range limit may be allowed for one zone cluster, whereas a second range limit can be applied for another zone cluster. As such, different areas can be associated with different distance thresholds, so that the specific distance threshold for a particular area can be determined based on the sidelink communication environment in the area, thereby improving the effectiveness of the distance threshold 915. In some embodiments, the distance threshold 915 may be specific to a radio link between the first and second terminal devices 120-1 and 120-2. For instance, if a terminal device has multiple simultaneous sidelink communication links with multiple terminal devices, then the distance threshold 915 can be per radio link configuration. For example, one radio link may use a first range limit, while another radio link can use a second range limit.

After determining (910) the distance threshold 915, the network device 110 may transmit the distance threshold 915 to one or both of the first terminal device 120-1 and the second terminal device 120-2. In the following, some embodiments will be described under the assumption that the network device 110 transmits (920) the distance threshold 915 to the first terminal device 120-1 without loss of generality. It is to be understood that embodiments of the present disclosure can equally apply to other scenarios in which the distance threshold 915 is merely transmitted to the second terminal device 120-2. In some embodiments, in addition to transmitting (920) the distance threshold 915 to the first terminal device 120-1, the network device 110 may also transmit (925) the distance threshold 915 to the second terminal device 120-2. Accordingly, the first terminal device 120-1 may receive (930) the distance threshold 915 from the network device 110, and in some embodiments, the second terminal device 120-2 can also receive (935) the distance threshold 915 from the network device 110.

Then, the first terminal device 120-1 may obtain (940) a sidelink resource for the first sidelink communication 125-1 based on the distance threshold 915. More particularly, in some embodiments, the first terminal device 120-1 may determine that the distance between the first terminal device 120-1 and the second terminal device 120-2 is smaller than the distance threshold 915, which means that the first sidelink communication 125-1 is not a remote sidelink communication. In these embodiments, the first terminal device 120-1 can obtain (940) the sidelink resource for the first sidelink communication 125-1 in a regular manner. For example, the sidelink resource can be determined by the network device 110 or can be selected by the first terminal device 120-1 from a predetermined sidelink resource pool.

In contrast, in some embodiments, the first terminal device 120-1 may determine that the distance between the first terminal device 120-1 and the second terminal device 120-2 is greater than the distance threshold 915, which means that the first sidelink communication 125-1 is a remote sidelink communication. In these embodiments, the first terminal device 120-1 can obtain (940) the sidelink resource for the first sidelink communication 125-1 in a special way that can reduce the potential interference onto be caused by the remote sidelink communication. Some embodiments of such a special way will be further described hereinafter.

After obtaining (940) the sidelink resource for the first sidelink communication 125-1, the first terminal device 120-1 may perform (950) the first sidelink communication 125-1 between the first terminal device 120-1 and the second terminal device 120-2 using the sidelink resource. For example, the first terminal device 120-1 may perform a sidelink transmission to the second terminal device 120-2 using the sidelink resource. From the perspective of the second terminal device 120-2, the second terminal device 120-2 can perform (960) the first sidelink communication 125-1 using the sidelink resource. For instance, the second terminal device 120-2 may receive a sidelink transmission from the first terminal device 120-1 using the sidelink resource. It is to be understood that if the second terminal device 120-2 is the transmitting device in the first sidelink communication 125-1, then the second terminal device 120-2 can obtain the sidelink resource for the first sidelink communication 125-1 based on the distance threshold 915. Then, the second terminal device 120-2 may transmit a sidelink transmission to the first terminal device 120-1 using the sidelink resource.

Through the communication process 900, the network device 110 can configure the distance threshold 915 for the first sidelink communication 125-1, and the first terminal device 110 can obtain the sidelink resource for the first sidelink communication 125-1 based on the distance threshold 915. Therefore, the potential severe interference that may be caused by a remote sidelink communication can be avoided, thereby improving the performance of the sidelink communications in the cell 112.

As described above, if the first terminal device 120-1 determines that the distance between the first terminal device 120-1 and the second terminal device 120-2 is greater than the distance threshold 915, then the first terminal device 120-1 can obtain (940) the sidelink resource for the first sidelink communication 125-1 in a special way. Some embodiments of such a special way will now be detailed.

As an example of such a special way, if the first terminal device 120-1 and the second terminal device 120-2 previously operate in the UE autonomous operation mode (Mode 2), then the first terminal device 120-1 and the second terminal device 120-2 need to fall back (or switch) to the network device controlled mode (Mode 1) automatically. In other words, if a sidelink resource for a previous sidelink communication between the first and second terminal devices 120-1 and 120-2 is determined by the transmitting device, then a sidelink resource for a subsequent sidelink communication between the first and second terminal devices 120-1 and 120-2 needs to be determined by the network device 110. In this way, the network device 110 can determine a proper sidelink resource for the first sidelink communication 125-1 as a remote sidelink communication, so as to avoid potential significant interference that would otherwise be caused by the remote sidelink communication.

More specifically, if the distance between the first terminal device 120-1 and the second terminal device 120-2 is greater than the distance threshold 915, the first terminal device 120-1 may transmit a request to the network device 110 for allocating a sidelink resource for the first sidelink communication 125-1. Upon receiving the request from the first terminal device 120-1, the network device 110 can determine the sidelink resource for the first sidelink communication 125-1, such that the first sidelink communication 125-1 is not to induce severe interference onto other sidelink communications in the cell 112. After determining the sidelink resource for the first sidelink communication 125-1, the network device 110 may transmit an indication of the sidelink resource to the first terminal device 120-1. Accordingly, the first terminal device 120-1 may receive the indication of the sidelink resource from the network device 110, and can obtain (940) the sidelink resource based on the indication.

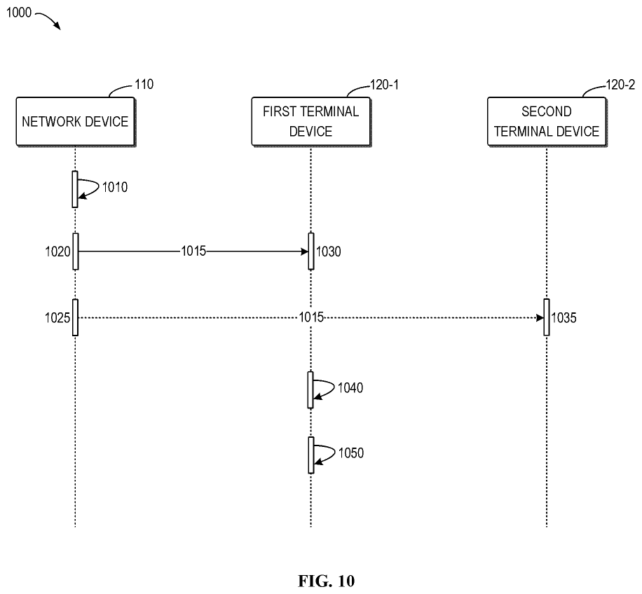

As another example of the special way, if the distance between the first and second terminal devices 120-1 and 120-2 is greater than the distance threshold 915, a dedicated sidelink resource pool can be activated and used for performing the first sidelink communication 125-1. That is, a remote sidelink communication determined according to the distance threshold 915 can be associated with the dedicated sidelink resource pool. In the case that the distance between the first and second terminal devices 120-1 and 120-2 is greater than the distance threshold 915 and thus the first sidelink communication 125-1 is a remote sidelink communication, then the dedicated sidelink resource pool may be used by the first and second terminal devices 120-1 and 120-2. Some embodiments will be further detailed below with reference to FIG. 10.

FIG. 10 illustrates an example of a communication process 1000 performed among the network device 110, the first terminal device 120-1, and the second terminal device 120-2 in accordance with some embodiments of the present disclosure. It is to be understood that although the communication process 1000 is depicted to be performed among the network device 110, the first terminal device 120-1 and the second terminal device 120-2, the communication process 1000 can similarly be performed among the network device 110 and any other terminal devices of the terminal devices 120. For the purpose of discussion, the communication process 1000 will be described with reference to FIGS. 1A and 1B. However, it would be appreciated that the communication process 1000 may equally apply to other communication scenarios in which communication devices communicate with one another.

As shown in FIG. 10, the network device 110 may determine (1010) a dedicated sidelink resource pool specific to a sidelink communication with a communication distance greater than the distance threshold. In other words, if a sidelink communication is a remote sidelink communication having a communication distance greater than the distance threshold 915, then the remote sidelink communication may need to be performed using the dedicated sidelink resource pool that may not be used by normal sidelink communication channels. In some embodiments, the network device 110 can assign specific resources to form the dedicated sidelink resource pool for a specific distance threshold 915. With the dedicated sidelink resource pool, a remote sidelink communication can be performed using a sidelink resource selected from the dedicated sidelink resource pool, thereby avoiding the potential significant interference that would otherwise be induced by the remote sidelink communication.

After determining (1010) the dedicated sidelink resource pool, the network device 110 may transmit an indication 1015 of the dedicated sidelink resource pool to one or both of the first terminal device 120-1 and the second terminal device 120-2. In the following, some embodiments will be described under the assumption that the network device 110 transmits (1020) the indication 1015 to the first terminal device 120-1 without loss of generality. It is to be understood that embodiments of the present disclosure can equally apply to other scenarios in which the indication 1015 is merely transmitted to the second terminal device 120-2. In some embodiments, in addition to transmitting (1020) the indication 1015 to the first terminal device 120-1, the network device 110 may also transmit (1025) the indication 1015 to the second terminal device 120-2. Accordingly, the first terminal device 120-1 may receive (1030) the indication 1015 from the network device 110, and can know the dedicated sidelink resource pool. In some embodiments, the second terminal device 120-2 can also receive (1035) the indication 1015 from the network device 110, and may know dedicated sidelink resource pool.

Since the dedicated sidelink resource pool is specific to a remote sidelink communication, if the distance between the first and second terminal devices 120-1 and 120-2 is greater than the distance threshold 915, then the first terminal device 120-1 needs to fall back to use the dedicated sidelink resource pool to avoid potential severe interference that may be induced by the remote sidelink communication. For example, in some scenarios, the first terminal device 120-1 may determine (1040) that the distance between the first and second terminal devices 120-1 and 120-2 is greater than the distance threshold 915. Then, the first terminal device 120-1 may determine (1050) the sidelink resource from the dedicated sidelink resource pool, thereby obtaining (940) the sidelink resource to reduce or eliminate the potential interference that may be caused by the remote sidelink communication. It is to be understood that if the second terminal device 120-2 is the transmitting device in the first sidelink communication 125-1, then the second terminal device 120-2 can determine that the distance between the first and second terminal devices 120-1 and 120-2 is greater than the distance threshold 915. Then, the second terminal device 120-2 may determine the sidelink resource for the first sidelink communication 125-1 from the dedicated sidelink resource pool.

Through the communication process 1000, a dedicated sidelink resource pool can be configured by the network device 110 to the terminal devices, and a sidelink resource can be selected by the first terminal device 120-1 from the dedicated sidelink resource pool for the first sidelink communication 125-1 as a remote sidelink communication, so as to avoid potential significant interference that would otherwise be caused by first sidelink communication 125-1 as a remote sidelink communication.

In some embodiments, the network device 110 can enable or disable the dedicated sidelink resource pool in an implicit or explicit manner. As an example of the implicit manner, the network device 110 may enable the dedicated sidelink resource pool by configuring the dedicated sidelink resource pool and indicating to the terminal devices. On the other hand, if the network device 110 does not configure the dedicated sidelink resource pool, then the dedicated sidelink resource pool is disabled implicitly. In this way, the flexibility of the function of the dedicated sidelink resource pool can be improved.

As an example of the explicit manner, the network device 110 may transmit an indication to one or both of the first and second terminal devices 120-1 and 120-2, for example, via Radio Resource Control (RRC) signalling, Medium Access Control (MAC) signalling, physical signalling, or the like. The indication can be used for explicitly indicating whether the dedicated sidelink resource pool is enabled or disabled. On the receiving side of the indication, the first terminal device 120-1 and/or the second terminal device 120-2 may receive the indication from the network device 110, and can determine from the indication whether the dedicated sidelink resource pool is enabled or disabled by the network device 110. In this way, the flexibility of the function of the dedicated sidelink resource pool can also be improved.

As described above, in some embodiments, the network device 110 may determine (910) the distance threshold 915 based on interference information reported by the first terminal device 120-1. Such embodiments will be further detailed below with reference to FIG. 11.

FIG. 11 illustrates an example of a communication process 1100 performed between the network device 110 and the first terminal device 120-1 in accordance with some embodiments of the present disclosure. It is to be understood that although the communication process 1100 is depicted to be performed between the network device 110 and the first terminal device 120-1, the communication process 1100 can similarly be performed between the network device 110 and any other terminal device of the terminal devices 120. For the purpose of discussion, the communication process 1100 will be described with reference to FIGS. 1A and 1B. However, it would be appreciated that the communication process 1100 may equally apply to other communication scenarios in which communication devices communicate with one another.

As shown in FIG. 11, the first terminal device 120-1 may transmit (1110) interference information 1115 to the network device 110. The interference information 1115 may be about interference detected by the first terminal device 120-1 and can reflect a sidelink communication load (also termed as a sidelink traffic load) in the cell 112. Therefore, the interference information 1115 may be used by the network device 110 to determine a more appropriate distance threshold 915. In some embodiments, the interference information 1115 may contain a magnitude of the interference (for example, a real interference value), a level (or status) of the interference (such as high interference, medium interference, low interference, or the like), a direction of the interference, or any combination thereof. As such, the network device 110 can obtain more comprehensive information on the interference among the sidelink communications in the cell 112. In some embodiments, may be transmitted to the network device 110 if the interference detected by the first terminal device 120-1 is greater than a predefined interference threshold. In some embodiments, the interference threshold can be configured or preconfigured by the network device 110 according to specific communication environments or performance requirements.

Upon receiving (1120) the interference information 1115 from the first terminal device 120-1, the network device may determine (1130) the sidelink communication load in the cell 112 based on the interference information 1115. For example, if the interference information 1115 indicates a high interference level, then the sidelink communication load may be high, and if the interference information 1115 indicates a low interference level, then the sidelink communication load may be low. More particularly, the sidelink communication load in the communication system 100 or 105 can be calculated by the network device 110 based on the reported interference information 1115. Then, the network device may determine (1140) the distance threshold 915 based on the sidelink communication load. In other words, the allowed sidelink communication range in the cell 112 can be associated to the sidelink communication load in the communication system 100 or 105. For example, if the sidelink communication load is higher a load threshold, the allowed sidelink communication range may be shortened by the network device 110.

Through the communication process 1100, the network device 110 can determine a more suitable distance threshold 915 in view of the interference level among the sidelink communications and the sidelink communication load in the cell 122, so as to enhance the resource utilization efficiency without inducing significant interference, thereby improving the performance of the sidelink communications in the cell 122.

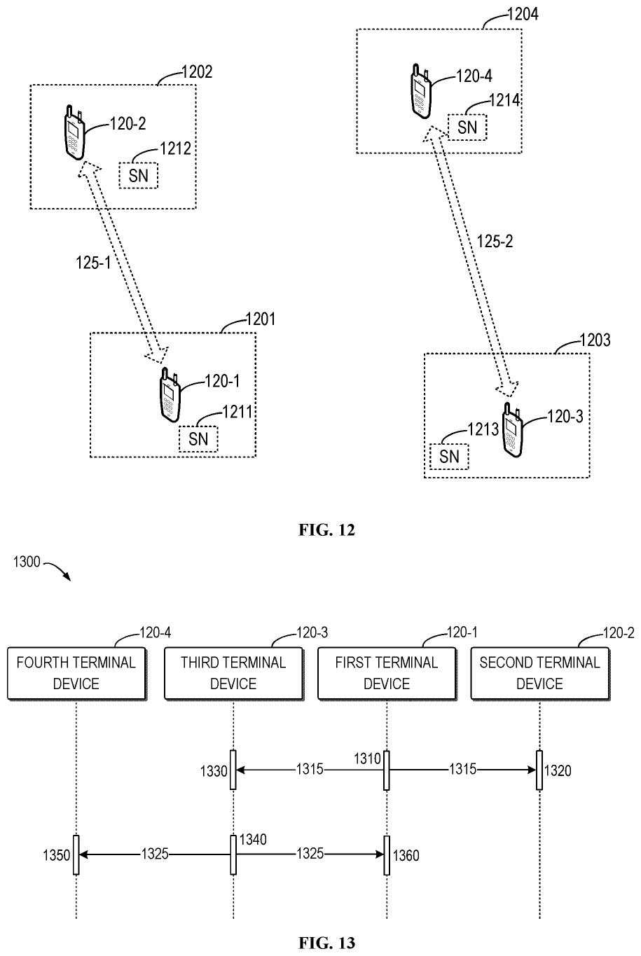

In some embodiments, two pairs of terminal devices can perform two sidelink communications in the UE autonomous operation mode in which the sidelink resource can be selected by a transmitting device in a sidelink communication. In these embodiments, two transmitting devices of the two sidelink communications can exchange assistance information for the purpose of sidelink resource management and interference control. For example, zone information associated with respective sidelink communications can be exchanged between the transmitting devices. Thus, a transmitting device in a sidelink communication can determine an optimized sidelink resource for the sidelink communication in view of the zone information associated with the other sidelink communication, thereby improving the performance of the sidelink communications. Such embodiments will be detailed below with reference to FIGS. 12 and 13.

FIG. 12 illustrates four terminal devices 120-1 to 120-4 and their respective associated zones 1201 to 1204 in accordance with some embodiments of the present disclosure. In the exemplary scenario of FIG. 12, it is assumed that the first terminal device 120-1 is currently located in the zone 1201 with a serial number 1211, the second terminal device 120-2 is currently located in the zone 1202 with a serial number 1212, the third terminal device 120-3 is currently located in the zone 1203 with a serial number 1213, and the fourth terminal device 120-2 is currently located in the zone 1204 with a serial number 1214. Accordingly, the zones 1201 to 1204 can be referred to as current zones 1201 to 1204 of the first to fourth terminal devices 120-1 to 120-4, respectively. In some embodiments, the first to fourth terminal devices 120-1 to 120-4 can be neighbouring terminal devices.

FIG. 13 illustrates an example of a communication process 1300 performed among the first terminal device 120-1, the second terminal device 120-2, the third terminal device 120-3, and the fourth terminal device 120-4 in accordance with some embodiments of the present disclosure. It is to be understood that although the communication process 1300 is depicted to be performed among the first terminal device 120-1, the second terminal device 120-2, the third terminal device 120-3, and the fourth terminal device 120-4, the communication process 1300 can similarly be performed among any other terminal devices of the terminal devices 120. For the purpose of discussion, the communication process 1300 will be described with reference to FIG. 12. However, it would be appreciated that the communication process 1300 may equally apply to other communication scenarios in which communication devices communicate with one another.

As shown in FIG. 13, the first terminal device 120-1 may transmit (1310) control information 1315 to the second terminal device 120-2. The control information 1315 may be configured for scheduling the first sidelink communication 125-1 between the first and second terminal devices 120-1 and 120-2. In addition, the control information 1315 may contain zone information associated with the first sidelink communication 125-1, for example, the serial number 1211 of the current zone 1201 in which the first terminal device 120-1 is located, and the serial number 1212 of the current zone 1202 in which the second terminal device 120-2 is located. Upon receiving (1320) the control information 1315 from the first terminal device 120-1, the second terminal device 120-2 can obtain the scheduling information of the first sidelink communication 125-1 from the control information 1315, and thus can perform the first sidelink communication 125-1 with the first terminal device 120-1.

As further shown in FIG. 13, the third terminal device 120-3 can also receive (1330) the control information 1315 from the first terminal device 120-1, so that the third terminal device 120-3 may obtain the zone information in the control information 1315. Based on the zone information associated with first sidelink communication 125-1, namely the serial numbers 1211 and 1212, the third terminal device 120-3 may determine the zones 1201 and 1202 in which the first terminal device 120-1 and the second terminal device 120-2 are located, respectively. Accordingly, if the third terminal device 120-3 is the transmitting device in the second sidelink communication 125-2, then the third terminal device 120-3 may determine the sidelink resource for the second sidelink communication 125-2 based on the zone information associated with the first sidelink communication 125-1. Therefore, the resource utilization efficiency can be enhanced and the interference can be reduced in the sidelink communications, thereby improving the performance of the sidelink communications.

Similarly, the third terminal device 120-3 may transmit (1340) control information 1325 to the fourth terminal device 120-4. The control information 1325 may be configured for scheduling the second sidelink communication 125-2 between the third and fourth terminal devices 120-3 and 120-4. In addition, the control information 1325 may contain zone information associated with the second sidelink communication 125-2, for example, the serial number 1213 of the current zone 1203 in which the third terminal device 120-3 is located, and the serial number 1214 of the current zone 1204 in which the fourth terminal device 120-4 is located. Upon receiving (1350) the control information 1325 from the third terminal device 120-3, the fourth terminal device 120-4 can obtain the scheduling information of the second sidelink communication 125-2 from the control information 1325, and thus can perform the second sidelink communication 125-2 with the third terminal device 120-3.

As further shown in FIG. 13, the first terminal device 120-1 can also receive (1360) the control information 1325 from the third terminal device 120-3, so that the first terminal device 120-1 may obtain the zone information in the control information 1325. Based on the zone information associated with second sidelink communication 125-2, namely the serial numbers 1213 and 1214, the first terminal device 120-1 may determine the zones 1203 and 1204 in which the third terminal device 120-3 and the fourth terminal device 120-4 are located, respectively. Accordingly, if the first terminal device 120-1 is the transmitting device in the first sidelink communication 125-1, then the first terminal device 120-1 may determine the sidelink resource for the first sidelink communication 125-1 based on the zone information associated with the second sidelink communication 125-2. Therefore, the resource utilization efficiency can be enhanced and the interference can be reduced in the sidelink communications, thereby improving the performance of the sidelink communications.

Through the communication process 1300, if two pairs of terminal devices perform two sidelink communications in the UE autonomous operation mode, the serial numbers of the zones associated with the two sidelink communications can be exchanged between transmitting devices of the two sidelink communications. Thus, a transmitting device in a sidelink communication can determine an appropriate sidelink resource for the sidelink communication in view of the zone information associated with the other sidelink communication, so as to enhance resource utilization efficiency and reduce interference in the sidelink communications.

For example, in the exemplary scenario of FIG. 7, it is assumed that the terminal devices 120 perform sidelink communications in the UE autonomous operation mode. With the communication process 1300, the potential interference that may be caused by the first sidelink communication 125-1 to the second sidelink communication 125-2 and/or the third sidelink communication 125-3 can be avoided.

### Example Method

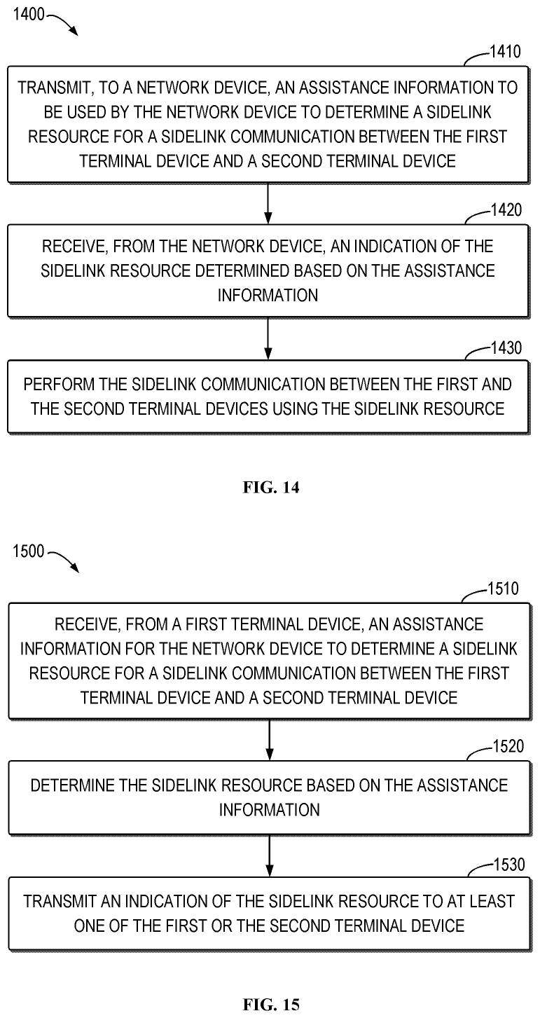

FIG. 14 illustrates a flowchart of an example method 1400 for communication in accordance with some embodiments of the present disclosure. In some embodiments, the method 1400 can be implemented at a device in a communication network, such as the first terminal device 120-1 as shown in FIGS. 1A and 1B. Additionally or alternatively, the method 1400 can be implemented at other devices shown in FIGS. 1A and 1B. In some other embodiments, the method 1400 may be implemented at devices not shown in FIGS. 1A and 1B. Further, it is to be understood that the method 1400 may include additional blocks not shown and/or may omit some blocks as shown, and the scope of the present disclosure is not limited in this regard. For the purpose of discussion, the method 1400 will be described from the perspective of the first terminal device 120-1 with reference to FIGS. 1A and 1B.

At block 1410, the first terminal device 120-1 may transmit an assistance information to the network device 110. The assistance information can be used by the network device 110 to determine a sidelink resource for a sidelink communication between the first terminal device 120-1 and the second terminal device 120-2. At block 1420, the first terminal device 120-1 can receive an indication from the network device 110. The indication can indicate the sidelink resource determined based on the assistance information. At block 1430, the first terminal device 120-1 may perform the sidelink communication between the first terminal device 120-1 and the second terminal device 120-2 using the sidelink resource.

In some embodiments, when transmitting the assistance information, the first terminal device 120-1 may transmit at least one of the following to the network device 110: a first serial number of a current zone in which the first terminal device 120-1 is located, or a second serial number of a future zone in which the first terminal device 120-1 is to be located.

In some embodiments, the at least one of the first or the second serial number is transmitted in accordance with at least one of the following: receipt of a request from the network device 110 for at least one of the first or the second serial number, a determination that a difference between the first serial number and a previously reported serial number is greater than a difference threshold, or a determination that a number of changes of the first serial number since a previously reported serial number is greater than a number threshold.

In some embodiments, the first terminal device 120-1 is a transmitting device in the sidelink communication, and when transmitting the assistance information, the first terminal device 120-1 can further transmit at least one of the following to the network device 110: a third serial number of a current zone in which the second terminal device 120-2 is located, or a fourth serial number of a future zone in which the second terminal device 120-2 is to be located.

In some embodiments, when transmitting the assistance information, the first terminal device 120-1 may transmit, to the network device 110, a distance information between the first terminal device 120-1 and the second terminal device 120-2.

In some embodiments, when transmitting the distance information, the first terminal device 120-1 may determine a current distance between the first terminal device 120-1 and the second terminal device 120-2; determine a previous distance between the first second terminal device 120-1 and the second terminal device 120-2 reported to the network device 110; and if a difference between the current distance and the previous distance is greater than a distance difference threshold, transmit the distance information to the network device 110.

In some embodiments, the distance information comprises a value of a distance between the first and the second terminal devices, or an indication of a value range including the value of the distance.

In some embodiments, the assistance information comprises a beamforming information on a directional beam used for the sidelink communication.

FIG. 15 illustrates a flowchart of an example method 1500 for communication in accordance with some embodiments of the present disclosure. In some embodiments, the method 1500 can be implemented at a device in a communication network, such as the network device 110 as shown in FIGS. 1A and 1B. Additionally or alternatively, the method 1500 can be implemented at other devices shown in FIGS. 1A and 1B. In some other embodiments, the method 1500 may be implemented at devices not shown in FIGS. 1A and 1B. Further, it is to be understood that the method 1500 may include additional blocks not shown and/or may omit some blocks as shown, and the scope of the present disclosure is not limited in this regard. For the purpose of discussion, the method 1500 will be described from the perspective of the network device 110 with reference to FIGS. 1A and 1B.

At block 1510, the network device 110 may receive an assistance information from the first terminal device 120-1. The assistance information can be used by the network device 110 to determine a sidelink resource for a sidelink communication between the first terminal device 120-1 and the second terminal device 120-2. At block 1520, the network device 110 can determine the sidelink resource based on the assistance information. At block 1530, the network device 110 may transmit an indication of the sidelink resource to at least one of the first terminal device 120-1 or the second terminal device 120-2.

In some embodiments, when receiving the assistance information, the network device 110 may receive at least one of the following from the first terminal device 120-1: a first serial number of a current zone in which the first terminal device 120-1 is located, or a second serial number of a future zone in which the first terminal device 120-1 is to be located.

In some embodiments, the network device 110 may further transmit, to the first terminal device 120-1, a request for at least one of the first or the second serial number.

In some embodiments, the first terminal device 120-1 is a transmitting device in the sidelink communication, and when receiving the assistance information, the network device 110 may further receive at least one of the following from the first terminal device 120-1: a third serial number of a current zone in which the second terminal device 120-2 is located, or a fourth serial number of a future zone in which the second terminal device 120-2 is to be located.

In some embodiments, when receiving the assistance information, the network device 110 may receive, from the first terminal device 120-1, a distance information between the first terminal device 120-1 and the second terminal device 120-2.

In some embodiments, the distance information comprises a value of a distance between the first and the second terminal devices or an indication of a value range including the value of the distance.

In some embodiments, the assistance information comprises a beamforming information on a directional beam used for the sidelink communication.

In some embodiments, the sidelink communication is a first sidelink communication, and when determining the sidelink resource, if the network device 110 determines, based on the beamforming information, that an interference onto be caused by the first sidelink communication to a second sidelink communication to be performed between the third terminal device 120-3 and the fourth terminal device 120-4 is below an interference threshold, the network device 110 can determine the sidelink resource for both the first and the second sidelink communications.

In some embodiments, the network device 110 is a first network device serving the first terminal device 120-1, and the assistance information is a first assistance information, and the network device 110 may further at least one of the following: transmit the first assistance information to a second network device 130 serving the second terminal device 120-2; or receive, from the second network device 130, a second assistance information transmitted by the second terminal device 120-2 to the second network device 130.

In some embodiments, the sidelink communication is a first sidelink communication, and when determining the sidelink resource, the network device 110 may at least one of the following: determine the sidelink resource to reduce an interference caused by the first sidelink communication to a second sidelink communication between the third terminal device 120-3 and the fourth terminal device 120-4; or determine the sidelink resource to reduce an interference caused by the second sidelink communication to the first sidelink communication.

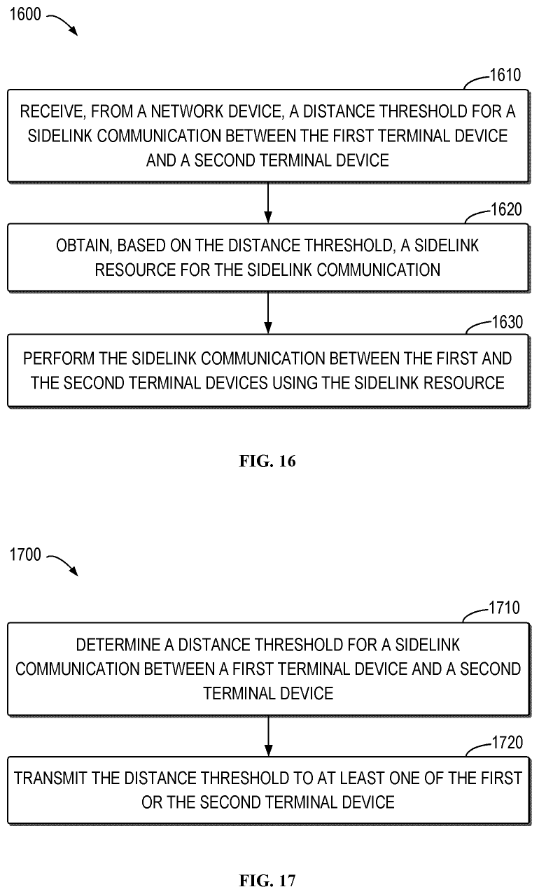

FIG. 16 illustrates a flowchart of an example method 1600 for communication in accordance with some embodiments of the present disclosure. In some embodiments, the method 1600 can be implemented at a device in a communication network, such as the first terminal device 120-1 as shown in FIGS. 1A and 1B. Additionally or alternatively, the method 1600 can be implemented at other devices shown in FIGS. 1A and 1B. In some other embodiments, the method 1600 may be implemented at devices not shown in FIGS. 1A and 1B. Further, it is to be understood that the method 1600 may include additional blocks not shown and/or may omit some blocks as shown, and the scope of the present disclosure is not limited in this regard. For the purpose of discussion, the method 1600 will be described from the perspective of the first terminal device 120-1 with reference to FIGS. 1A and 1B.

At block 1610, the first terminal device 120-1 may receive a distance threshold from the network device 110. The distance threshold can be used for a sidelink communication between the first terminal device 120-1 and the second terminal device 120-2. At block 1620, the first terminal device 120-1 can obtain a sidelink resource for the sidelink communication based on the distance threshold. At block 1630, the first terminal device 120-1 may perform the sidelink communication between the first terminal device 120-2 and the second terminal device 120-2 using the sidelink resource.

In some embodiments, when obtaining the sidelink resource, if a distance between the first terminal device 120-1 and the second terminal device 120-2 is greater than the distance threshold, the first terminal device 120-1 may transmit a request to the network device 110 for allocating a sidelink resource for the sidelink communication; and receive an indication of the sidelink resource from the network device 110.

In some embodiments, when obtaining the sidelink resource, the first terminal device 120-1 can receive, from the network device 110, an indication of a dedicated sidelink resource pool specific to a sidelink communication with a communication distance greater than the distance threshold; and if a distance between the first terminal device 120-1 and the second terminal devices 120-2 is greater than the distance threshold, the first terminal device 120-1 can determine the sidelink resource from the dedicated sidelink resource pool.

In some embodiments, the first terminal device 120-1 may further receive, from the network device 110, an indication for indicating whether the dedicated sidelink resource pool is enabled or disabled.

In some embodiments, the first terminal device 120-1 can further transmit, to the network device 110, an interference information on an interference detected by the first terminal device 120-1, such that the network device determines the distance threshold based on the interference information.

In some embodiments, the interference information comprises at least one of a magnitude, a level, or a direction of the interference.

In some embodiments, the distance threshold is specific to at least one of the following: an area including a set of zones, or a radio link between the first terminal device 120-1 and the second terminal device 120-2.

In some embodiments, the first terminal device 120-1 can further transmit, to the second terminal device 120-2, a control information for scheduling the sidelink communication, and the control information contains a first serial number of a current zone in which the first terminal device 120-1 is located and a second serial number of a current zone in which the second terminal device 120-2 is located.

In some embodiments, the sidelink communication is a first sidelink communication, and when obtaining the sidelink resource, the first terminal device 120-1 may receive, from the third terminal device 120-3, a control information for scheduling a second sidelink communication between the third terminal device 120-3 and the fourth terminal device 120-4, and the control information contains a first serial number of a current zone in which the third terminal device 120-3 is located and a second serial number of a current zone in which the fourth terminal device 120-4 is located; and determine the sidelink resource for the first sidelink communication further based on the first and second serial numbers.

FIG. 17 illustrates a flowchart of an example method 1700 for communication in accordance with some embodiments of the present disclosure. In some embodiments, the method 1700 can be implemented at a device in a communication network, such as the network device 110 as shown in FIGS. 1A and 1B. Additionally or alternatively, the method 1700 can be implemented at other devices shown in FIGS. 1A and 1B. In some other embodiments, the method 1700 may be implemented at devices not shown in FIGS. 1A and 1B. Further, it is to be understood that the method 1700 may include additional blocks not shown and/or may omit some blocks as shown, and the scope of the present disclosure is not limited in this regard. For the purpose of discussion, the method 1700 will be described from the perspective of the network device 110 with reference to FIGS. 1A and 1B.

At block 1710, the network device 110 may determine a distance threshold for a sidelink communication between a first terminal device 120-1 and the second terminal device 120-2. At block 1720, the network device 110 can transmit the distance threshold to at least one of the first terminal device 120-1 or the second terminal device 120-2.

In some embodiments, the network device 110 may further determine a dedicated sidelink resource pool specific to a sidelink communication with a communication distance greater than the distance threshold; and transmit an indication of the dedicated sidelink resource pool to at least one of the first terminal device 120-1 or the second terminal device 120-2.

In some embodiments, the network device 110 may further transmit, to at least one of the first terminal device 120-1 or the second terminal device 120-2, an indication for indicating whether the dedicated sidelink resource pool is enabled or disabled.

In some embodiments, when determining the distance threshold, the network device 110 may receive, from the first terminal device 120-1, an interference information on an interference detected by the first terminal device 120-1; determine a sidelink communication load based on the interference information; and determine the distance threshold based on the sidelink communication load.

In some embodiments, the interference information comprises at least one of a magnitude, a level, or a direction of the interference.

In some embodiments, when determining the distance threshold, the network device 110 may determine the distance threshold based on at least one of a traffic type of the sidelink communication or locations of the first terminal device 120-1 and the second terminal device 120-2.

In some embodiments, the distance threshold is specific to at least one of the following: an area including a set of zones, or a radio link between the first terminal device 120-1 and the second terminal device 120-2.

### Example Apparatus

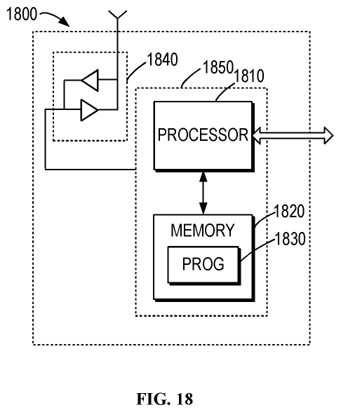

FIG. 18 illustrates a simplified block diagram of an apparatus 1800 (also termed as a device 1800) that is suitable for implementing embodiments of the present disclosure. The apparatus 1800 can be considered as a further example implementation of the network device 110 and the terminal devices 120 as shown in FIGS. 1A to 1C. Accordingly, the apparatus 1800 can be implemented at or as at least a part of the network device 110 and the terminal devices 120.

As shown, the apparatus 1800 includes a processor 1810, a memory 1820 coupled to the processor 1810, a suitable transmitter (TX) and receiver (RX) 1840 coupled to the processor 1810, and a communication interface coupled to the TX/RX 1840. The memory 1820 stores at least a part of a program 1830. The TX/RX 1840 is for bidirectional communications. The TX/RX 1840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), Uu interface for communication between the eNB and a terminal device, or PC5 interface for communication between two terminal devices.

The program 1830 is assumed to include program instructions that, when executed by the associated processor 1810, enable the apparatus 1800 to operate in accordance with the embodiments of the present disclosure, as discussed herein. The embodiments herein may be implemented by computer software executable by the processor 1810 of the apparatus 1800, or by hardware, or by a combination of software and hardware. The processor 1810 may be configured to implement various embodiments of the present disclosure. Furthermore, a combination of the processor 1810 and memory 1820 may form processing means 1850 adapted to implement various embodiments of the present disclosure.

The memory 1820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1820 is shown in the apparatus 1800, there may be several physically distinct memory modules in the apparatus 1800. The processor 1810 may be of any type suitable to the local technical network, and may include one or more of general purpose computers, special purpose computers, microprocessors, digital signal processors (DSPs) and processors based on multicore processor architecture, as non-limiting examples. The apparatus 1800 may have multiple processors, such as an application specific integrated circuit chip that is slaved in time to a clock which synchronizes the main processor.

In some embodiments, an apparatus capable of performing the method 1400 (for example, the first terminal device 120-1) may comprise means for performing the respective steps of the method 1400. The means may be implemented in any suitable form. For example, the means may be implemented in a circuitry or software module.

In some embodiments, the apparatus comprises means for transmitting, to a network device, an assistance information to be used by the network device to determine a sidelink resource for a sidelink communication between the first terminal device and a second terminal device. The apparatus also comprises means for receiving, from the network device, an indication of the sidelink resource determined based on the assistance information. The apparatus further comprises means for performing the sidelink communication between the first and the second terminal devices using the sidelink resource.

In some embodiments, the means for transmitting the assistance information comprises: means for transmitting at least one of the following to the network device: a first serial number of a current zone in which the first terminal device is located, or a second serial number of a future zone in which the first terminal device is to be located.

In some embodiments, the at least one of the first or the second serial number is transmitted in accordance with at least one of the following: receipt of a request from the network device for at least one of the first or the second serial number, a determination that a difference between the first serial number and a previously reported serial number is greater than a difference threshold, or a determination that a number of changes of the first serial number since a previously reported serial number is greater than a number threshold.

In some embodiments, the first terminal device is a transmitting device in the sidelink communication, and the means for transmitting the assistance information further comprises: means for transmitting at least one of the following to the network device: a third serial number of a current zone in which the second terminal device is located, or a fourth serial number of a future zone in which the second terminal device is to be located.

In some embodiments, the means for transmitting the assistance information comprises: means for transmitting, to the network device, a distance information between the first and the second terminal devices.

In some embodiments, the means for transmitting the distance information comprises: means for determining a current distance between the first and the second terminal devices; means for determining a previous distance between the first and the second terminal devices reported to the network device; and means for in accordance with a determination that a difference between the current distance and the previous distance is greater than a distance difference threshold, transmitting the distance information to the network device.

In some embodiments, the distance information comprises a value of a distance between the first and the second terminal devices, or an indication of a value range including the value of the distance.

In some embodiments, the assistance information comprises beamforming information on a directional beam used for the sidelink communication.

In some embodiments, the apparatus further comprises means for performing other steps in some embodiments of the method 1400. In some embodiments, the means comprises at least one processor and at least one memory including computer program code, the at least one memory and computer program code configured to, with the at least one processor, cause the performance of the method 1400.

In some embodiments, an apparatus capable of performing the method 1500 (for example, the network device 110) may comprise means for performing the respective steps of the example method 1500. The means may be implemented in any suitable form. For example, the means may be implemented in a circuitry or software module.

In some embodiments, the apparatus comprises means for receiving, from a first terminal device, an assistance information for to be used by network device to determine a sidelink resource for a sidelink communication between the first terminal device and a second terminal device. The apparatus also comprises means for determining the sidelink resource based on the assistance information. The apparatus further comprises means for transmitting an indication of the sidelink resource to at least one of the first or the second terminal device.

In some embodiments, the means for receiving the assistance information comprises: means for receiving at least one of the following from the first terminal device: a first serial number of a current zone in which the first terminal device is located, or a second serial number of a future zone in which the first terminal device is to be located.

In some embodiments, the apparatus further comprises: means for transmitting, to the first terminal device, a request for at least one of the first or the second serial number.

In some embodiments, the first terminal device is a transmitting device in the sidelink communication, and the means for receiving the assistance information further comprises: means for receiving at least one of the following from the first terminal device: a third serial number of a current zone in which the second terminal device is located, or a fourth serial number of a future zone in which the second terminal device is to be located.

In some embodiments, the means for receiving the assistance information comprises: means for receiving, from the first terminal device, a distance information between the first and the second terminal devices.

In some embodiments, the distance information comprises a value of a distance between the first and the second terminal devices or an indication of a value range including the value of the distance.

In some embodiments, the assistance information comprises a beamforming information on a directional beam used for the sidelink communication.

In some embodiments, the sidelink communication is a first sidelink communication, and the means for determining the sidelink resource comprises: means for in accordance with a determination, based on the beamforming information, that an interference to be caused by the first sidelink communication to a second sidelink communication to be performed between a third terminal device and a fourth terminal device is below an interference threshold, determining the sidelink resource for both the first and the second sidelink communications.

In some embodiments, the network device is a first network device serving the first terminal device, and the assistance information is a first assistance information, and the apparatus further comprises at least one of the following: means for transmitting the first assistance information to a second network device serving the second terminal device; or means for receiving, from the second network device, a second assistance information transmitted by the second terminal device to the second network device.

In some embodiments, the sidelink communication is a first sidelink communication, and the means for determining the sidelink resource comprises at least one of the following: means for determining the sidelink resource to reduce an interference caused by the first sidelink communication to a second sidelink communication between a third terminal device and a fourth terminal device; or means for determining the sidelink resource to reduce an interference caused by the second sidelink communication to the first sidelink communication.

In some embodiments, the apparatus further comprises means for performing other steps in some embodiments of the method 1500. In some embodiments, the means comprises at least one processor and at least one memory including computer program code, the at least one memory and computer program code configured to, with the at least one processor, cause the performance of the method 1500.

In some embodiments, an apparatus capable of performing the method 1600 (for example, the first terminal device 120-1) may comprise means for performing the respective steps of the method 1600. The means may be implemented in any suitable form. For example, the means may be implemented in a circuitry or software module.

In some embodiments, the apparatus comprises means for receiving, from a network device, a distance threshold for a sidelink communication between the first terminal device and a second terminal device. The apparatus also comprises means for obtaining, based on the distance threshold, a sidelink resource for the sidelink communication. The apparatus further comprises means for performing the sidelink communication between the first and the second terminal devices using the sidelink resource.

In some embodiments, the means for obtaining the sidelink resource comprises: means for in accordance with a determination that a distance between the first and the second terminal devices is greater than the distance threshold, transmitting a request to the network device for allocating a sidelink resource for the sidelink communication; and means for receiving an indication of the sidelink resource from the network device.

In some embodiments, the means for obtaining the sidelink resource comprises: means for receiving, from the network device, an indication of a dedicated sidelink resource pool specific to a sidelink communication with a communication distance greater than the distance threshold; and means for in accordance with a determination that a distance between the first and the second terminal devices is greater than the distance threshold, determining the sidelink resource from the dedicated sidelink resource pool.

In some embodiments, the apparatus further comprise: means for receiving, from the network device, an indication for indicating whether the dedicated sidelink resource pool is enabled or disabled.

In some embodiments, the apparatus further comprises: means for transmitting, to the network device, an interference information on an interference detected by the first terminal device, such that the network device determines the distance threshold based on the interference information.

In some embodiments, the interference information comprises at least one of a magnitude, a level, or a direction of the interference.

In some embodiments, the distance threshold is specific to at least one of the following: an area including a set of zones, or a radio link between the first and the second terminal devices.

In some embodiments, the apparatus further comprises: means for transmitting, to the second terminal device, a control information for scheduling the sidelink communication, the control information containing a first serial number of a current zone in which the first terminal device is located and a second serial number of a current zone in which the second terminal device is located.

In some embodiments, the sidelink communication is a first sidelink communication, and the means for obtaining the sidelink resource comprises: means for receiving, from a third terminal device, a control information for scheduling a second sidelink communication between the third terminal device and a fourth terminal device, the control information containing a first serial number of a current zone in which the third terminal device is located and a second serial number of a current zone in which the fourth terminal device is located; and means for determining the sidelink resource for the first sidelink communication further based on the first and the second serial numbers.

In some embodiments, the apparatus further comprises means for performing other steps in some embodiments of the method 1600. In some embodiments, the means comprises at least one processor and at least one memory including computer program code, the at least one memory and computer program code configured to, with the at least one processor, cause the performance of the method 1600.

In some embodiments, an apparatus capable of performing the method 1700 (for example, the network device 110) may comprise means for performing the respective steps of the example method 1700. The means may be implemented in any suitable form. For example, the means may be implemented in a circuitry or software module.

In some embodiments, the apparatus comprises means for determining a distance threshold for a sidelink communication between a first terminal device and a second terminal device. The apparatus also comprises means for transmitting the distance threshold to at least one of the first or the second terminal device.

In some embodiments, the apparatus further comprises: means for determining a dedicated sidelink resource pool specific to a sidelink communication with a communication distance greater than the distance threshold; and means for transmitting an indication of the dedicated sidelink resource pool to at least one of the first or the second terminal device.

In some embodiments, the apparatus further comprises: means for transmitting, to at least one of the first or the second terminal device, an indication for indicating whether the dedicated sidelink resource pool is enabled or disabled.

In some embodiments, the means for determining the distance threshold comprises: means for receiving, from the first terminal device, an interference information on an interference detected by the first terminal device; means for determining a sidelink communication load based on the interference information; and means for determining the distance threshold based on the sidelink communication load.

In some embodiments, the interference information comprises at least one of a magnitude, a level, or a direction of the interference.

In some embodiments, the means for determining the distance threshold comprises: means for determining the distance threshold based on at least one of a traffic type of the sidelink communication or locations of the first and the second terminal devices.

In some embodiments, the distance threshold is specific to at least one of the following: an area including a set of zones, or a radio link between the first and the second terminal devices.

In some embodiments, the apparatus further comprises means for performing other steps in some embodiments of the method 1700. In some embodiments, the means comprises at least one processor and at least one memory including computer program code, the at least one memory and computer program code configured to, with the at least one processor, cause the performance of the method 1700.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.

1. A method performed by a first terminal device, comprising: transmitting, to a network device, an assistance information to be used by the network device to determine a sidelink resource for a sidelink communication between the first terminal device and a second terminal device; receiving, from the network device, an indication of the sidelink resource determined based on the assistance information; and performing the sidelink communication between the first and the second terminal devices using the sidelink resource.

2. The method of clause 1, wherein transmitting the assistance information comprises: transmitting at least one of the following to the network device: a first serial number of a current zone in which the first terminal device is located, or a second serial number of a future zone in which the first terminal device is to be located.

3. The method of clause 2, wherein the at least one of the first or the second serial number is transmitted in accordance with at least one of the following: receipt of a request from the network device for at least one of the first or the second serial number, a determination that a difference between the first serial number and a previously reported serial number is greater than a difference threshold, or a determination that a number of changes of the first serial number since a previously reported serial number is greater than a number threshold.

4. The method of clause 2, wherein the first terminal device is a transmitting device in the sidelink communication, and wherein transmitting the assistance information further comprises: transmitting at least one of the following to the network device: a third serial number of a current zone in which the second terminal device is located, or a fourth serial number of a future zone in which the second terminal device is to be located.

5. The method of clause 1, wherein transmitting the assistance information comprises: transmitting, to the network device, a distance information between the first and the second terminal devices.

6. The method of clause 5, wherein transmitting the distance information comprises: determining a current distance between the first and the second terminal devices; determining a previous distance between the first and the second terminal devices reported to the network device; and in accordance with a determination that a difference between the current distance and the previous distance is greater than a distance difference threshold, transmitting the distance information to the network device.

7. The method of clause 5, wherein the distance information comprises a value of a distance between the first and the second terminal devices, or an indication of a value range including the value of the distance.

8. The method of clause 1, wherein the assistance information comprises a beamforming information on a directional beam used for the sidelink communication.

9. A method performed by a network device, comprising: receiving, from a first terminal device, an assistance information for the network device to determine a sidelink resource for a sidelink communication between the first terminal device and a second terminal device; determining the sidelink resource based on the assistance information; and transmitting an indication of the sidelink resource to at least one of the first or the second terminal device.

10. The method of clause 9, wherein receiving the assistance information comprises: receiving at least one of the following from the first terminal device: a first serial number of a current zone in which the first terminal device is located, or a second serial number of a future zone in which the first terminal device is to be located.

11. The method of clause 10, further comprising: transmitting, to the first terminal device, a request for at least one of the first or the second serial number.

12. The method of clause 10, wherein the first terminal device is a transmitting device in the sidelink communication, and wherein receiving the assistance information further comprises: receiving at least one of the following from the first terminal device: a third serial number of a current zone in which the second terminal device is located, or a fourth serial number of a future zone in which the second terminal device is to be located.

13. The method of clause 9, wherein receiving the assistance information comprises: receiving, from the first terminal device, a distance information between the first and the second terminal devices.

14. The method of clause 13, wherein the distance information comprises a value of a distance between the first and the second terminal devices or an indication of a value range including the value of the distance.

15. The method of clause 9, wherein the assistance information comprises a beamforming information on a directional beam used for the sidelink communication.

16. The method of clause 15, wherein the sidelink communication is a first sidelink communication, and wherein determining the sidelink resource comprises: in accordance with a determination, based on the beamforming information, that an interference to be caused by the first sidelink communication to a second sidelink communication to be performed between a third terminal device and a fourth terminal device is below an interference threshold, determining the sidelink resource for both the first and the second sidelink communications.

17. The method of clause 9, wherein the network device is a first network device serving the first terminal device, and the assistance information is a first assistance information, and wherein the method further comprises at least one of the following: transmitting the first assistance information to a second network device serving the second terminal device; or receiving, from the second network device, a second assistance information transmitted by the second terminal device to the second network device.

18. The method of clause 9, wherein the sidelink communication is a first sidelink communication, and wherein determining the sidelink resource comprises at least one of the following: determining the sidelink resource to reduce an interference caused by the first sidelink communication to a second sidelink communication between a third terminal device and a fourth terminal device; or determining the sidelink resource to reduce an interference caused by the second sidelink communication to the first sidelink communication.

19. A method performed by a first terminal device, comprising: receiving, from a network device, a distance threshold for a sidelink communication between the first terminal device and a second terminal device; obtaining, based on the distance threshold, a sidelink resource for the sidelink communication; and performing the sidelink communication between the first and the second terminal devices using the sidelink resource.

20. The method of clause 19, wherein obtaining the sidelink resource comprises: in accordance with a determination that a distance between the first and the second terminal devices is greater than the distance threshold, transmitting a request to the network device for allocating a sidelink resource for the sidelink communication; and receiving an indication of the sidelink resource from the network device.

21. The method of clause 19, wherein obtaining the sidelink resource comprises: receiving, from the network device, an indication of a dedicated sidelink resource pool specific to a sidelink communication with a communication distance greater than the distance threshold; and in accordance with a determination that a distance between the first and the second terminal devices is greater than the distance threshold, determining the sidelink resource from the dedicated sidelink resource pool.

22. The method of clause 21, further comprising: receiving, from the network device, an indication for indicating whether the dedicated sidelink resource pool is enabled or disabled.

23. The method of clause 19, further comprising: transmitting, to the network device, an interference information on an interference detected by the first terminal device, such that the network device determines the distance threshold based on the interference information.

24. The method of clause 23, wherein the interference information comprises at least one of a magnitude, a level, or a direction of the interference.

25. The method of clause 19, wherein the distance threshold is specific to at least one of the following: an area including a set of zones, or a radio link between the first and the second terminal devices.

26. The method of clause 19, further comprising: transmitting, to the second terminal device, a control information for scheduling the sidelink communication, the control information containing a first serial number of a current zone in which the first terminal device is located and a second serial number of a current zone in which the second terminal device is located.

27. The method of clause 19, wherein the sidelink communication is a first sidelink communication, and wherein obtaining the sidelink resource comprises: receiving, from a third terminal device, a control information for scheduling a second sidelink communication between the third terminal device and a fourth terminal device, the control information containing a first serial number of a current zone in which the third terminal device is located and a second serial number of a current zone in which the fourth terminal device is located; and determining the sidelink resource for the first sidelink communication further based on the first and the second serial numbers.

28. A method performed by a network device, comprising: determining a distance threshold for a sidelink communication between a first terminal device and a second terminal device; and transmitting the distance threshold to at least one of the first or the second terminal device.

29. The method of clause 28, further comprising: determining a dedicated sidelink resource pool specific to a sidelink communication with a communication distance greater than the distance threshold; and transmitting an indication of the dedicated sidelink resource pool to at least one of the first or the second terminal device.

30. The method of clause 29, further comprising: transmitting, to at least one of the first or the second terminal device, an indication for indicating whether the dedicated sidelink resource pool is enabled or disabled.

31. The method of clause 28, wherein determining the distance threshold comprises: receiving, from the first terminal device, an interference information on an interference detected by the first terminal device; determining a sidelink communication load based on the interference information; and determining the distance threshold based on the sidelink communications load.

32. The method of clause 31, wherein the interference information comprises at least one of a magnitude, a level, or a direction of the interference.

33. The method of clause 28, wherein determining the distance threshold comprises: determining the distance threshold based on at least one of a traffic type of the sidelink communication or locations of the first and the second terminal devices.

34. The method of clause 28, wherein the distance threshold is specific to at least one of the following: an area including a set of zones, or a radio link between the first and the second terminal devices.

35. A first terminal device comprising: a processor; and a memory storing instructions, the memory and the instructions being configured, with the processor, to cause the terminal device to perform the method of any of clauses 1-8 and 19-27.

36. A network device comprising: a processor; and a memory storing instructions, the memory and the instructions being configured, with the processor, to cause the network device to perform the method of any of clauses 9-18 and 28-34.

37. A computer readable medium having instructions stored thereon, the instructions, when executed on at least one processor of a device, causing the device to perform the method of any of clauses 1-8 and 19-27.

38. A computer readable medium having instructions stored thereon, the instructions, when executed on at least one processor of a device, causing the device to perform the method of any of clauses 9-18 and 28-34.

1. A method performed by a first terminal device, comprising:
transmitting, to a network device, assistance information to be used by the network device to determine a sidelink resource for a sidelink communication between the first terminal device and a second terminal device;
receiving, from the network device, an indication of the sidelink resource determined based on the assistance information; and
performing the sidelink communication between the first terminal device and the second terminal device using the sidelink resource.

2. The method of claim 1, wherein transmitting the assistance information comprises:
transmitting, to the network device, at least one of a first serial number of a current zone in which the first terminal device is located, or a second serial number of a future zone in which the first terminal device is to be located.

3. The method of claim 2, wherein the at least one of the first serial number or the second serial number is transmitted in accordance with at least one of:
receipt of a request from the network device for at least one of the first serial number or the second serial number,
a first determination that a difference between the first serial number and a previously reported serial number is greater than a difference threshold, or
a second determination that a number of changes of the first serial number since the previously reported serial number is greater than a number threshold.

4. The method of claim 2, wherein the first terminal device is a transmitting device in the sidelink communication, and wherein transmitting the assistance information further comprises:
transmitting, to the network device, at least one of a third serial number of an additional current zone in which the second terminal device is located, or a fourth serial number of an additional future zone in which the second terminal device is to be located.

5. The method of claim 1, wherein transmitting the assistance information comprises:
transmitting, to the network device, a distance information between the first terminal device and the second terminal device.

6. The method of claim 5, wherein transmitting the distance information comprises:
determining a current distance between the first terminal device and the second terminal device;
determining a previous distance between the first terminal device and the second terminal device reported to the network device; and
in accordance with a determination that a difference between the current distance and the previous distance is greater than a distance difference threshold, transmitting the distance information to the network device.

7. The method of claim 1, wherein the assistance information comprises beamforming information on a directional beam used for the sidelink communication.

8. An apparatus, comprising:
a processor; and
a memory coupled with the processor, the processor configured to cause the apparatus to:
receive, from a network device, a distance threshold for a sidelink communication between the apparatus and a terminal device;
obtain, based on the distance threshold, a sidelink resource for the sidelink communication; and
perform the sidelink communication between the apparatus and the terminal device using the sidelink resource.

9. The apparatus of claim 8, wherein, to obtain the sidelink resource, the processor is configured to cause the apparatus to:
in accordance with a determination that a distance between the apparatus and the terminal device is greater than the distance threshold, transmitting a request to the network device for allocating the sidelink resource for the sidelink communication; and
receive an indication of the sidelink resource from the network device.

10. The apparatus of claim 8, wherein, to obtain the sidelink resource, the processor is configured to cause the apparatus to:
receive, from the network device, an indication of a dedicated sidelink resource pool specific to the sidelink communication with a communication distance greater than the distance threshold; and
in accordance with a determination that a distance between the apparatus and the terminal device is greater than the distance threshold, determine the sidelink resource from the dedicated sidelink resource pool.

11. The apparatus of claim 10, wherein the processor is configured to cause the apparatus to receive, from the network device, an additional indication of whether the dedicated sidelink resource pool is enabled or disabled.

12. The apparatus of claim 8, wherein the processor is configured to cause the apparatus to transmit, to the network device, interference information of an interference detected by the apparatus, wherein the network device determines the distance threshold based on the interference information.

13. The apparatus of claim 8, wherein the processor is configured to cause the apparatus to transmit, to the terminal device, control information for scheduling the sidelink communication, the control information containing a first serial number of a current zone in which the apparatus is located and a second serial number of an additional current zone in which the terminal device is located.

14. The apparatus of claim 8, wherein the sidelink communication is a first sidelink communication, and wherein, to obtain the sidelink resource, wherein the processor is configured to cause the apparatus to:
receive, from a second terminal device, control information for scheduling a second sidelink communication between the second terminal device and a third terminal device, the control information containing a first serial number of a current zone in which the second terminal device is located and a second serial number of an additional current zone in which the third terminal device is located; and
determine the sidelink resource for the first sidelink communication is further based on the first serial number and the second serial number.

15. An apparatus, comprising:
a processor; and
a memory coupled with the processor, the processor configured to cause the apparatus to:
transmit, to a network device, an assistance information to be used by the network device to determine a sidelink resource for a sidelink communication between the apparatus and a terminal device;
receiving, from the network device, an indication of the sidelink resource determined based on the assistance information; and
performing the sidelink communication between the apparatus and the terminal device using the sidelink resource.

16. The apparatus of claim 15, wherein, to transmit the assistance information, the processor is configured to cause the apparatus to transmit, to the network device, at least one of a first serial number of a current zone in which the apparatus is located, or a second serial number of a future zone in which the apparatus is to be located.

17. The apparatus of claim 16, wherein the at least one of the first serial number or the second serial number is transmitted in accordance with at least one of:
receipt of a request from the network device for at least one of the first serial number or the second serial number;
a first determination that a difference between the first serial number and a previously reported serial number is greater than a difference threshold; or
a second determination that a number of changes of the first serial number since the previously reported serial number is greater than a number threshold.

18. The apparatus of claim 16, wherein:
the apparatus is a transmitting device in the sidelink communication; and
to transmit the assistance information, the processor is configured to cause the apparatus to transmit, to the network device, at least one of a third serial number of an additional current zone in which the terminal device is located, or a fourth serial number of an additional future zone in which the terminal device is to be located.

19. The apparatus of claim 15, wherein, to transmit the assistance information, the processor is configured to cause the apparatus to transmit, to the network device, a distance information between the apparatus and the terminal device.

20. The apparatus of claim 19, wherein, to transmit the distance information, the processor is configured to cause the apparatus to:
determine a current distance between the apparatus and the terminal device;
determine a previous distance between the apparatus and the terminal device reported to the network device; and
transmit the distance information to the network device based at least in part on a determination that a difference between the current distance and the previous distance is greater than a distance difference threshold.
